(19) United States
(12) Patent Application Publication
(10) Pub. No.: US 2025/0153078 A1
(43) Pub. Date: May 15, 2025

(54) VALVE SYSTEMS FOR A HYBRID FILTER

(71) Applicant: Pentair Water Pool and Spa, Inc., Cary, NC (US)

(72) Inventors: Azur Dzindo, Raleigh, NC (US); Thomas Johnson Safon, Holly Springs, NC (US); Caleb Ray, Apex, NC (US); Anas Alhajeh, Clayton, NC (US); Alexander Smith, Fuquay-Varina, NC (US); Donnie Fore, Sanford, NC (US); Eric Pinnell, Holly Springs, NC (US); Kenneth Koch, Apex, NC (US); Dana Stephanie Royer Adams, Holly Springs, NC (US); Sean McEwan, Chapel Hill, NC (US)

(21) Appl. No.: 18/949,316

(22) Filed: Nov. 15, 2024

Related U.S. Application Data
(60) Provisional application No. 63/599,492, filed on Nov. 15, 2023.

(51) Int. Cl. B01D 37/04; B01D 29/66; B01D 35/147

(52) U.S. Cl. CPC B01D 37/04; B01D 29/668; B01D 35/147

(57) ABSTRACT

A hybrid filter assembly for an aquatic application is provided in the form of a vessel, a first filtration stage, a second filtration stage, a bypass assembly, and a controller. The vessel includes a first port which receives fluid from the aquatic application. The first filtration stage and the second filtration stage are retained in the vessel. The first filtration stage is designed to filter particles imparted with a first size, while the second filtration stage is designed to filter particles imparted with a second size. The bypass assembly is in fluid communication with a second port the vessel. The controller is in communication with the bypass assembly, and the controller actuates the bypass assembly to alter an operational state of the hybrid filter assembly.

### CROSS-REFERENCE TO RELATED APPLICATIONS

This Application claims priority to U.S. Provisional Patent Application Ser. No. 63/599,492, filed on Nov. 15, 2023, entitled “VALVE SYSTEM FOR HYBRID FILTER,” currently pending, the entire disclosure of which is incorporated herein by reference.

### TECHNICAL FIELD

This disclosure generally relates to valving systems for filters. More particularly, the disclosure relates to backwash and bypass valving systems for a hybrid two-stage filter for an aquatic application.

### BACKGROUND

Filtration systems are an important aspect of maintaining water clarity and quality in aquatic systems. Contaminants containing bacteria or pathogens may be introduced into bodies of water by environmental sources. Other contaminants or debris may be introduced by swimmers and bathers, including sweat, urine, bodily oils or secretions, suntan lotion, and other substances. In addition to contributing to high turbidity, contaminants can also react with disinfectant chemicals to produce chloramines and other disinfection by-products, which can contribute to adverse health effects. Thus, in pool and spa systems, to clean the water, the water is typically passed through a filtration system. Filtration systems are used to remove pollutants and contaminants to reduce turbidity and to promote the visual clarity of the water. Filtration systems are one mechanism used to help ensure healthy conditions in swimming pools, hot tubs, spas, plunge pools, and other recreational water venues or aquatic applications.

Traditional pool and spa filtration technologies include diatomaceous earth filters, pressure-fed sand filters, gravity sand filters, and cartridge filters. However, these filtration technologies have inherent shortcomings, including the inability to capture small, suspended solids, bacteria, and viruses without the use of filter aids. Conversely, high-efficiency filter media capable of capturing submicron particles and microorganisms may become clogged when processing larger suspended solids. Thus, high-efficiency filter media such as hollow fiber membrane technology is traditionally employed through the use of one or more externally located pre-filter(s) to capture larger particles.

Traditional filter systems can be cleaned through backwash operations, in which the flow of water is reversed through the system to loosen and remove trapped particulates. However, conventional valving arrangements can create dead spaces in the filter during backwashing. Typically, membrane filters can include a cap or plug in a top portion of the membrane filter to prevent fluid from escaping the top of the module during a backwash procedure. However, the plug can create an area of low or no flow in the top portion of the module. Thus, the overall efficiency of the membrane filter can be reduced because some portion of the module may not be properly cleaned during the backwash procedure.

Moreover, backwash operations can be time-consuming and difficult because a user may need to manually adjust the orientation of multiple valves to achieve the desired flow path through the filter. Additionally, The National Standard Institution (NSF)/American National Standards Institute (ANSI) 50-2021 Standard requires all filters and pressure vessels to include an internal air bypass. However, during operation of the filters, the internal air bypass can allow untreated water to bypass the filtration media. Thus, conventional air-bypass valves can reduce the efficacy of the filter. Furthermore, typical backwash operations take the entire filter system offline, thereby stopping all filtration of the water of the pool or spa.

Therefore, there is a need for a filtration system that can effectively filter out both large and small contaminants without becoming clogged. Furthermore, there is a need for valve systems that improve filter efficiency and are easier to operate.

### SUMMARY

In some aspects, a hybrid filter assembly for an aquatic application is provided in the form of a vessel, a first filtration stage, a second filtration stage, a bypass assembly, and a controller. The vessel includes a first port which receives fluid from the aquatic application. The first filtration stage and the second filtration stage are retained in the vessel. The first filtration stage is designed to filter particles imparted with a first size, while the second filtration stage is designed to filter particles imparted with a second size. The bypass assembly is in fluid communication with a second port the vessel. The controller is in communication with the bypass assembly, and the controller actuates the bypass assembly to alter an operational state of the hybrid filter assembly.

In some instances, the operational state of the hybrid filter assembly includes a filtration mode, a cleaning mode, and a bypass mode.

In other instances, the second port is provided in the form of a drain port which is in fluid communication with a waste system.

In yet other instances, substantially all the fluid from the aquatic application bypasses the second filtration stage when the operational state of the hybrid filter assembly is in a bypass mode.

In some instances, the vessel also includes a third port in fluid communication with an outlet conduit, and the outlet conduit is designed to provide filtered water from the hybrid filter assembly to the aquatic application. In some such instances, the bypass assembly includes a bypass conduit in communication with the third port of the vessel and a bypass valve in fluid communication with the bypass conduit. A filtered fluid is provided to the bypass conduit when the bypass valve is in a first configuration. In some further such instances, the bypass valve is retained within a bottom portion of the vessel and is positioned below the second filtration stage, whereas in other such instances the bypass valve is positioned outside of the vessel and the bypass valve is in fluid communication with the vessel via the second port.

In other instances, the hybrid filter further includes a backwash assembly in fluid communication with the first port and a third port of the vessel. The backwash assembly is provided in the form of a first backwash valve and a second backwash valve. The second backwash valve is in fluid communication with the first backwash valve. The backwash assembly is designed to provide a fluid from the aquatic application to the vessel when the hybrid filter assembly operates in a filtration mode and is further designed to provide a backwash fluid to the vessel when the hybrid filter assembly operates in a cleaning mode.

In yet other instances, the controller can initiate a bypass mode to operate concurrently with a filtration mode and the second filtration stage is substantially fluidly isolated from the first filtration stage when the bypass mode is operational. In some such instances, the controller activates the bypass mode when the controller initiates a chemical cleaning of the second filtration stage.

In other aspects, a hybrid filter assembly for a pool or spa is provided in the form of a first filtration stage and a second filtration stage arranged within a vessel, an inlet conduit, an outlet conduit, a backwash valve assembly, and a bypass assembly. The second filtration stage includes a plurality of filtration modules. In some instances, the first filtration stage and the plurality of filtration modules filter water provided from the pool or spa. The inlet conduit and the outlet conduit are each in fluid communication with the filtration vessel. The inlet conduit is designed to provide a fluid from the pool or spa to the hybrid filter assembly, while the outlet conduit is designed to provide a filtered fluid from the filtration vessel to the pool or spa. The backwash valve assembly includes a valve system designed to provide a backwashing fluid to the filtration vessel when the hybrid filter assembly operates in a backwash mode. The bypass assembly includes a bypass valve in fluid communication with a drain port of the filtration vessel, and the bypass assembly is designed to selectively fluidly isolate the second filtration stage.

In some instances, the hybrid filter assembly also includes a controller in electronic communication with the backwash valve assembly and the bypass assembly. In some such instances, the controller actuates the valve system of the backwash valve assembly at a first time period to provide the backwashing fluid to the first filtration stage, and the controller actuates the bypass valve of the bypass assembly at a second time period to fluidly isolate the second filtration stage from the first filtration stage.

In other instances, the hybrid filter assembly also includes a bypass conduit designed to place the bypass valve into fluid communication with the drain port and the outlet conduit.

In yet other instances, fluid is provided from the first filtration stage to the bypass conduit and the outlet conduit when the bypass valve is in an open configuration.

In yet other aspects, a hybrid filter assembly for an aquatic application is provided in the form of a filtration vessel, a first conduit, a second conduit, a backwash valve assembly, and a bypass valve assembly. The filtration vessel includes a first port, a second port, and a third port each including an aperture extending through a body of the filtration vessel. The first conduit is in fluid communication with the first port and a source of fluid from the aquatic application, while the second conduit is in fluid communication with the second port and designed to provide an output of the filtration vessel to the aquatic application. The backwash valve assembly is provided in the form of a first valve, a second valve, and a valve conduit coupled to each of the first valve and the second valve. The bypass valve assembly is designed to selectively allow fluid to exit the filtration vessel via the third port.

In some instances, the bypass valve assembly of the hybrid filter assembly also includes a bypass valve, a rotatable shaft, and an actuator. The bypass valve is positioned in an interior of the filtration vessel. The rotatable shaft is coupled to the bypass valve, with the rotatable shaft extending from an interior of the filtration vessel and outwardly and away from the body of the filtration vessel. The actuator is in communication with the rotatable shaft and the rotatable shaft is designed to actuate the bypass valve between an open configuration and a closed configuration.

In other instances, the filtration vessel includes a granular media arranged upstream of a filtration module, and the fluid from the aquatic application bypasses the filtration module when a bypass valve of the bypass valve assembly is in an open configuration. In some such instances, substantially all of the fluid provided from the aquatic application flows through the filtration module and exits the filtration vessel via the second conduit when the bypass valve is in a closed configuration.

In yet other instances, fluid is provided from the first filtration stage to the bypass conduit and the outlet conduit when the bypass valve is in an open configuration.

### DESCRIPTION OF THE DRAWINGS

FIG. 1 is a schematic diagram depicting a swimming pool and one or more components associated with a pool pad;

FIG. 2 is a front isometric view of a hybrid filter assembly constructed in accordance with the teachings herein;

FIG. 3A is a cross-sectional view of the hybrid filter assembly of FIG. 2, with some portions removed for clarity;

FIG. 3B is a partial top elevational view of some of the internal components of the hybrid filter assembly of FIG. 2, with some portions removed for clarity;

FIG. 4A is a top elevational view of a bottom portion of the hybrid filter assembly of FIG. 2 showing a manifold;

FIG. 4B is a top isometric view of a bottom portion of the hybrid filter assembly of FIG. 2;

FIG. 5A is a top isometric view of a bottom portion of the hybrid filter assembly of FIG. 2 with a second filtration stage disposed therein;

FIG. 5B is a side isometric view of the bottom portion of the hybrid filter assembly of FIG. 5A with some portions removed for clarity;

FIG. 6A is a side elevational view of a membrane filtration module of the hybrid filter assembly of FIG. 5A with some portions removed for clarity;

FIG. 6B is a partial cross-sectional side view of a membrane filtration module of FIG. 6A taken along the line 6B-6B of FIG. 6A;

FIG. 7A is a side elevational view of a membrane filtration module of the hybrid filter assembly of FIG. 2 further including a media guard;

FIG. 7B is a partial cross-sectional side view of the membrane filtration module of FIG. 7A taken along the line 7B-7B of FIG. 7A;

FIG. 8 is a partial cross-sectional view of the hybrid filter assembly of FIG. 2, showing a fluid flow path through the assembly during a normal filtration operation with some portions removed for clarity;

FIG. 9 is a partial cross-sectional side view of the membrane filtration module of FIGS. 5A and 5B showing a fluid flow path through the membrane filtration module during a normal operation of the hybrid filter assembly, with some portions removed for clarity;

FIG. 10 is a partial cross-sectional side view of the membrane filtration module of FIG. 9, showing a fluid flow path through the membrane filtration module during a backwash operation, with some portions removed for clarity;

FIG. 11 is a partial cross-sectional side view of the hybrid filter assembly of FIG. 2, showing a fluid flow path through the assembly during a backwash mode with some portions removed for clarity;

FIG. 12 is a partial cross-sectional view of a membrane module of the hybrid filter assembly of FIG. 2, including a check valve assembly;

FIG. 13A is a top isometric view of the check valve assembly of FIG. 12;

FIG. 13B is a side isometric view of the check valve assembly of FIG. 12;

FIG. 13C is a cross-sectional view of the check valve assembly of FIG. 12 taken along the line 13C-13C of FIG. 13B;

FIG. 14 illustrates a fluid flow path through the membrane module of FIG. 12 during a filtration operation with some portions removed for clarity;

FIG. 15 illustrates a fluid flow path through the membrane module of FIG. 12 during a backwash operation with some portions removed for clarity;

FIG. 16 is a schematic block diagram of a hybrid filter valving assembly including a backwash valve assembly and a chemical cleaning system;

FIG. 17 is a schematic block diagram of another hybrid filter valving assembly including a backwash valve assembly and a chemical cleaning system;

FIG. 18 is an isometric view of a backwash valve assembly coupled to a vessel;

FIG. 19 is an isometric view of the hybrid filter assembly of FIG. 2 coupled to a bypass assembly and a backwash valve assembly, with some portions of the hybrid filter assembly removed and some portions of the hybrid filter assembly rendered transparently for clarity;

FIG. 20 is a right-side elevational view of the hybrid filter assembly of FIG. 19;

FIG. 21 is a top isometric view of the backwash valve assembly of FIG. 19;

FIG. 22 illustrates a fluid flow path through the hybrid filter assembly of FIG. 20 when the hybrid filter assembly operates in a filtration mode in conjunction with a bypass mode;

FIG. 23 illustrates a fluid flow path through the hybrid filter assembly of FIG. 20 when the hybrid filter assembly operates in a backwash mode in conjunction with a bypass mode;

FIG. 24 illustrates a fluid flow path through the hybrid filter assembly of FIG. 20 when the hybrid filter assembly operates in a backwash mode;

FIG. 25 is an isometric view of the hybrid filter assembly of FIG. 2 coupled to a backwash valve assembly and another bypass assembly, with some portions of the hybrid filter assembly removed and some portions of the hybrid filter assembly rendered transparently for clarity;

FIG. 26A illustrates a schematic block diagram of a swimming pool and the hybrid filter assembly of FIG. 2 operating in a filtration mode;

FIG. 26B illustrates a schematic block diagram of a swimming pool and the hybrid filter assembly of FIG. 2 operating in a first backwash mode;

FIG. 26C illustrates a schematic block diagram of a swimming pool and the hybrid filter assembly of FIG. 2 operating in a second backwash mode;

FIG. 26D illustrates a schematic block diagram of a swimming pool, a chemical cleaning system, and the hybrid filter assembly of FIG. 2 operating in a chemical cleaning mode;

FIG. 26E illustrates a schematic block diagram of a swimming pool and the hybrid filter assembly of FIG. 2 operating in a bypass mode;

FIG. 27 is a schematic illustration of an automated internal air-bleed bypass valve system including a float;

FIG. 28 is a schematic illustration of another automated internal air-bleed bypass valve including a float; and

FIG. 29 is a schematic illustration of yet another internal air-bleed bypass valve including a passive, air permeable, water impermeable membrane.

### DETAILED DESCRIPTION

Before any embodiments are described in detail, it is to be understood that the disclosure is not limited in its application to the details of construction and the arrangement of components set forth in the following description or illustrated in the following drawings, which is limited only by the claims that follow the present disclosure. The disclosure is capable of other embodiments, and of being practiced, or of being carried out, in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following description is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, in which like elements in different figures have like reference numerals. Skilled artisans will recognize the examples provided herein have many useful alternatives and fall within the scope of embodiments of the disclosure.

Additionally, while the following discussion may describe features associated with specific devices, it is understood that additional devices and or features can be used with the described systems and methods, and that the discussed devices and features are used to provide examples of possible embodiments, without being limited.

The present disclosure provides a two-stage hybrid filter assembly designed for use in an aquatic application (e.g., pool or spa). The hybrid filter assembly is provided in the form of a high-efficiency, single-pass device. The two-stage filtration assembly is entirely retained and/or enclosed within a single vessel (e.g., housing) and can capture both larger suspended solids and submicron particles within a single pass of the fluid through the vessel. A first filtration stage employs depth filtration designed to capture large particulates and acts as a pre-filter for a second filtration stage. The second filtration stage is provided in the form of a membrane filtration module having one or more membranes designed to capture submicron particulates, bacteria, and/or viruses. Thus, by being able to capture both large and small suspended solids in an aquatic system, the two-stage filtration device can filter out contaminants such as skin cells, pollen, algae spores, and microorganisms such as bacteria and viruses that may not be effectively filtered out in traditional pool and spa systems. Therefore, the two-stage filtration system provides improved water clarity, decreased disinfection by-product formation, and decreased demand for a primary recreational water sanitizer and balancer, along with more consistent sanitizer and balancer levels in the water. Further, the hybrid filter assembly allows both stages of the filtration device to be backwashed simultaneously.

The hybrid filter assembly is designed to operate as a filtration device within a body of water or aquatic application, particularly a pool or spa system, to supplement and/or entirely replace a main filter, such as a traditional sand, cartridge, or diatomaceous earth filter. Traditional pool and spa filters are generally capable of capturing particles between about 3 to about 30 microns in size. In contrast, in some instances, the hybrid filter assembly disclosed herein is designed to capture particles larger than about 150 microns in size, particularly in the range of about 200 microns to about 300 microns in size in the first filtration stage and is capable of capturing particles larger than about 0.005 microns in size, particularly in the range of about 0.02 to about 0.20 microns in the second filtration stage. In some forms, the first filtration stage captures particles that are about 10 microns or larger in size. In other instances, the hybrid filter assembly disclosed herein is designed to capture particles larger than 150 microns in size, particularly in the range of 200 microns to 300 microns in size in the first filtration stage and is capable of capturing particles larger than 0.005 microns in size, particularly in the range of 0.02 to 0.20 microns in the second filtration stage. In some forms, the first filtration stage captures particles that are 10 microns or larger in size.

The hybrid filter assembly described herein may include various valve assemblies that may be actuated to place the hybrid filter assembly in different operational states, such as a filtration mode, a cleaning mode (e.g., a backwash mode, a chemical cleaning mode), a bypass mode, combinations thereof, and/or variations thereof. For example, the hybrid filter assembly may include a backwash valve assembly designed to provide a backwashing fluid to the first filtration stage and/or the second filtration stage. As another example, the hybrid filter assembly may include a bypass valve assembly designed to fluidly isolate the second filtration stage from the first filtration stage. In addition, the various operational modes described herein (e.g., the filtration mode, the backwash mode, the chemical cleaning mode, the bypass mode) may be operated sequentially, operated concurrently, implemented manually, and/or initiated automatically. In some instances, a first operational mode may be initiated at a first time period and a second operational mode may be initiated at a second time period.

It may be advantageous to fluidly isolate the second filtration stage from the first filtration stage under various operational conditions, e.g., when the second filtration stage and/or components of the second filtration stage undergo a chemical cleaning process and/or a chemical soaking process. By fluidly isolating the second filtration stage from the first filtration stage, some filtration capabilities of the hybrid filter assembly may be maintained even if the second filtration stage undergoes a cleaning process or is otherwise offline.

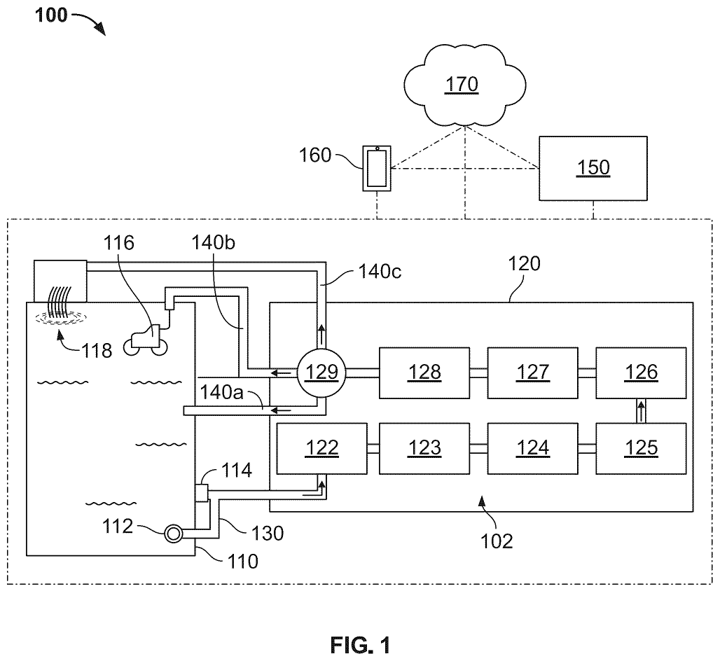

Referring to FIG. 1, a block diagram of an aquatic application 100 is depicted. The aquatic application 100 is provided in the form of one or more pool components 102 designed for use with a swimming pool 110. The pool components 102 include plumbing (e.g., conduits) and one or more pool management devices that form a closed loop fluid circuit. The pool components 102 may include one or more of an inlet conduit 130, a variable speed pump 122, a booster pump 123, a filter 124, a heater 125, a sanitizer 126, a water chemistry monitor 127, a water chemistry regulator 128, one or more valves 129, and one or more discharge conduits 140a-140c. One or more of the pool components 102 can be located on a pool pad 120.

In certain instances, the aquatic application 100 may be provided in the form of a spa and include components designed for use with a spa. In other instances, the aquatic application 100 may be provided in the form of a pool and a spa and include components that may be used with a pool and spa system. In yet other instances, the aquatic application 100 may be provided in the form of pool and/or spa components designed for use with a pool and/or a spa in a residential setting or a commercial setting. More particularly, the aquatic application 100 may be provided as a swimming pool, a hot tub, a spa, a plunge pool, and other recreational water venues not specifically discussed herein.

Portions of water can flow from the swimming pool 110 through the inlet conduit 130 from a drain 112 and/or a skimmer 114 and to a suction side of the variable speed pump 122. The variable speed pump 122 and/or the booster pump 123 can provide a driving force for the pool water to flow through the other downstream pool components 102. After the water from the swimming pool 110 exits one or more discharge conduits 140a-140c, the water can be optionally provided directly to the swimming pool 110 and/or provided to additional pool components 102 such as a pool cleaner 116 and a water feature 118.

Referring specifically to the pool pad 120, the sanitizer 126 and the water chemistry regulator 128 are designed to control one or more water treatment chemicals that can be added to the swimming pool 110. For example, in some embodiments, the sanitizer 126 is designed to add chlorine and/or bromine to the aquatic application 100. In some embodiments, the water chemistry regulator 128 is designed to add one or more pool chemicals such as hydrochloric acid, sodium bisulfate, carbon dioxide, sulfuric acid, sodium carbonate, or other water treatment chemicals to the aquatic application 100. Further, the heater 125 is optionally included and is designed to heat the water in the aquatic application 100.

It is to be understood that the pool components 102 can be provided in various configurations (i.e., the order of the pool components 102 can be altered). Further, in some embodiments, one or more pool components 102 may be omitted or removed from the aquatic application 100.

Still referring to FIG. 1, the aquatic application 100 can further include a central controller 150 and a user device 160 that can interface with the central controller 150 either directly over a local area network or via a cloud network 170. The central controller 150 can be a gateway, a hub, a switch, a router, a server, a switch, or other connection device to allow integration, monitoring, and control of multiple aspects of the aquatic application 100. The user device 160 can be provided in the form of a cell phone, tablet, or any other similar portable electronic device that may include a camera and a user interface.

Although FIG. 1 depicts the central controller 150 in communication with the user device 160 and the cloud network 170, it should be noted that various communication methodologies and connections may be implemented to work in conjunction with, or independent from, one or more local controllers associated with one or more individual components associated with the aquatic application 100 (e.g., a pump controller, a heater controller, etc.). For example, one or more of the central controller and the local controllers may utilize a Local Area Network (LAN), a Wide Local Area Network (WLAN), Ultra Mobile Broadband (UMB), Institute of Electrical and Electronics Engineers (IEEE) 802.11 (Wi-Fi), IEEE 802.16 (WiMAX), IEEE 802.20, Flash-OFDM, a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein, to transmit and receive information.

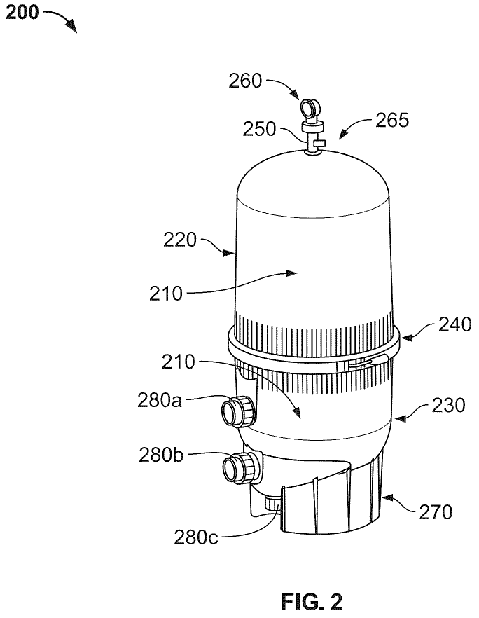

Now turning to FIG. 2, a filtration system provided in the form of a hybrid filter assembly 200 according to one embodiment of the disclosure is shown. The hybrid filter assembly 200 may be the filter 124 of FIG. 1. The hybrid filter assembly 200 is provided in the form of a filtration vessel 210, including a two-stage filtration assembly disposed entirely therein, which is discussed in detail below. As shown, the filtration vessel 210 is substantially cylindrically shaped. However, it is to be understood that the filtration vessel 210 may be imparted with any other shape. The filtration vessel 210 may be made from polymeric materials, such as thermoplastics, which can have inherent resistance to common environmental and chemical stressors.

As shown, the filtration vessel 210 is provided in the form of an upper housing 220 and a lower housing 230 that are releasably coupled together to form a substantially enclosed interior filtration chamber. Various known methods may be used to couple the upper housing 220 and the lower housing 230. For example, as shown, a circumferential retaining device 240 produced predominantly of a suitably corrosion-resistant material, such as stainless steel for example, can engage one or more interconnecting flanges on ends of the upper housing 220 and/or the lower housing 230, respectively, to provide a fluid tight seal as well as structural support therebetween. In another embodiment, an elastomeric seal (not shown) may be provided between interconnecting flanges which extend from one or both of the upper housing 220 and the lower housing 230. In yet another embodiment, a series of bolted fasteners (not shown) can be used to couple the upper housing 220 to the lower housing 230. In other embodiments, the filtration vessel 210 may be provided as an inseparable assembly or as a unitary housing structure.

Still referring to FIG. 2, the upper housing 220 may include one or more ports extending partially or completely through the upper housing 220 and designed to connect additional components to the hybrid filter assembly 200. As shown, the upper housing includes a first port 250 positioned at a top surface and extending at least partially through the upper housing 220. A pressure gauge 260 can be coupled to the first port 250. An external air relief valve 265 can be positioned between the pressure gauge 260 and the first port 250 and can be configured to automatically release pressure from within the filtration vessel 210 or may be manually operated.

The lower housing 230 may include a base 270 extending from a lower end thereof that is designed to provide stability and support the hybrid filter assembly 200. The lower housing 230 can also include one or more ports (e.g., three ports 280a-280c) to facilitate fluid flow into and/or out of the hybrid filter assembly 200. The one or more ports provided on the lower housing 230 may extend partially or completely therethrough. An inlet port 280a permits water (e.g., fluid) to flow into the hybrid filter assembly 200, and an outlet port 280b and a drain port 280c designed to allow water and other components (e.g., waste fluid, backwashing fluid, and the like) to flow out of the hybrid filter assembly 200. The inlet port 280a and the outlet port 280b can be in fluid communication with one or more components of the aquatic application 100 of FIG. 1. In one embodiment, the drain port 280c can be connected to a waste system. In one embodiment, the drain port 280c can drain to the environment (e.g., the ground). In some instances, the drain port 280c can be provided as a threaded plug that has an elastomeric seal to provide a substantially fluid tight connection.

Additional ports (not shown) can be included in the upper housing 220 and/or the lower housing 230. The additional ports can be employed to provide additional benefits, such as improved deaeration of the second filtration stage, and/or provide supplemental operational status indicators through externally connected devices, such as gauges or transducers. In other embodiments, the supplemental devices may be provided as internally connected devices.

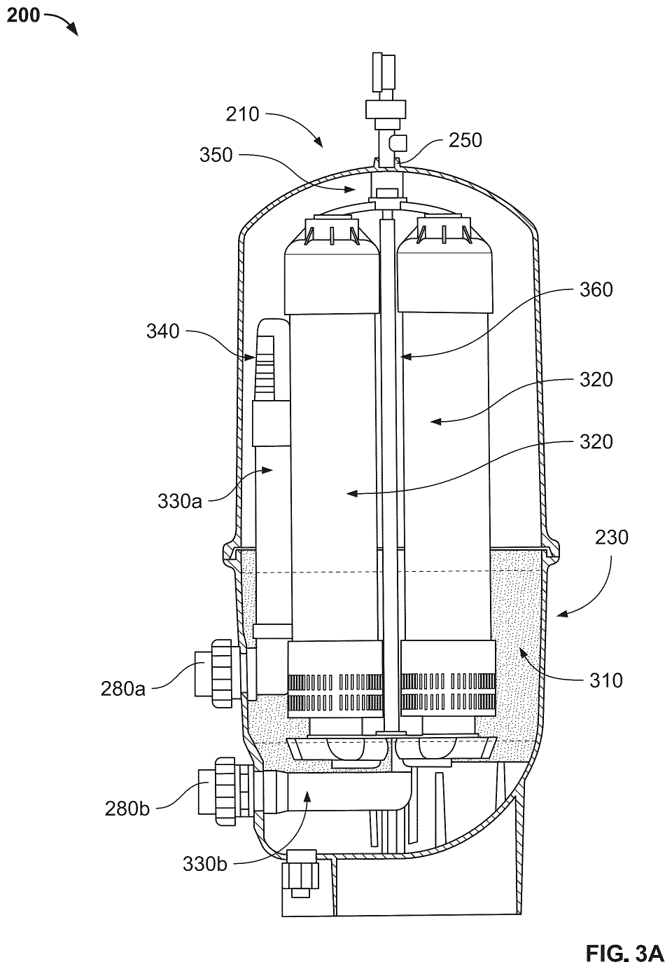

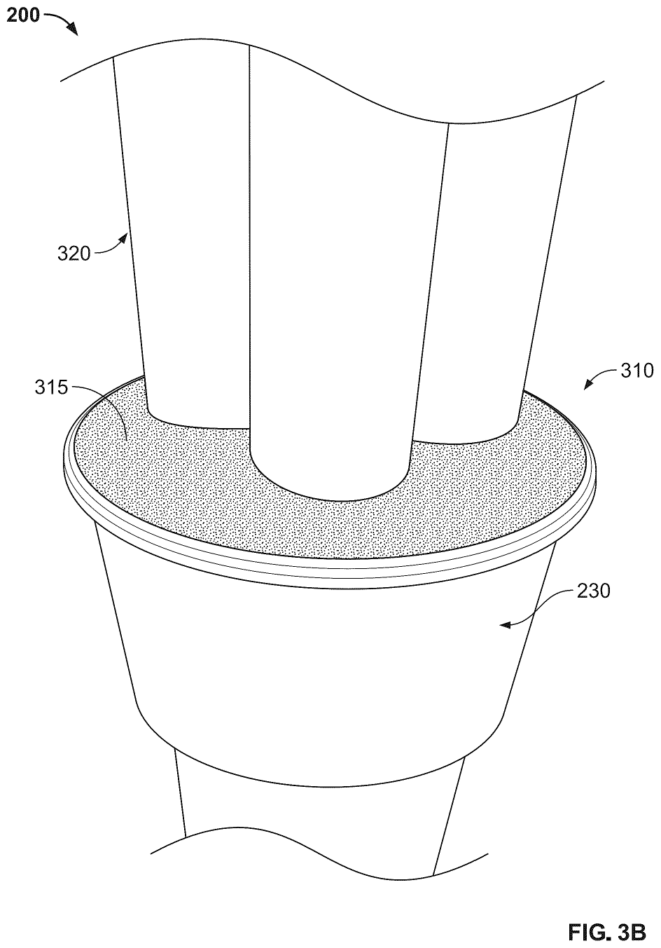

Turning to FIGS. 3A and 3B, various internal components of the hybrid filter assembly 200 of FIG. 2 are shown. The hybrid filter assembly 200 is defined by a two-stage filtration system comprising a first filtration stage 310 and a second filtration stage 320. Each of the first filtration stage 310 and the second filtration stage 320 may be operated under the principle of using pressure-driven filtration. In some instances, the pressure used to operate the hybrid filter assembly 200 may be provided by the variable speed pump 122, the booster pump 123, and/or another pump in fluid communication with the aquatic application 100 of FIG. 1.

Referring first to FIG. 3A, a first filtration stage 310 may be positioned in the lower housing 230 of the filtration vessel 210 and acts as a “prefilter” for the second filtration stage 320. The first filtration stage 310 is disposed in the lower housing 230 and substantially surrounds one or more filtration modules of the second filtration stage 320. In some forms, the first filtration stage 310 is provided in the form of porous media. The first filtration stage 310 operates using depth filtration by capturing debris within the volume of the porous media. Specifically, as fluid flows through the porous media, the depth and pore size of the media create a physical barrier in which particulates get trapped in the media itself. In some instances, the first filtration stage 310 includes a granular media 315 provided in the form of sand, crushed glass, an activated media such as carbon, pea gravel, activated glass media, and/or other suitable filtration media. For example, the first filtration stage 310 may be provided in the form of an activated filter media (e.g., an activated glass media including metal oxide catalysts) imparted with self-sterilization or antimicrobial properties. In such instances, the activated filter media may prevent bacteria-induced degradation of the efficacy of the first filtration stage via filter media mud-balling, coagulation, and channeling. In addition, in certain instances, the activated filter media (e.g., an activated glass media) may be imparted with a negative charge to facilitate the adsorption of sub-micron particulates and dissolved organic molecules. In some instances, the first filtration stage 310 is capable of capturing particles larger than the second filtration stage. By capturing large particles in the first filtration stage 310, the second filtration stage 320 can work more effectively because it may not become clogged with larger debris particles.

As discussed in more detail below, the second filtration stage 320 may include one or more membrane filtration modules that are arranged in an upright orientation. The membrane filtration modules can be provided in the form of a membrane filter, such as a reverse osmosis filter, nanofiltration filter, ultrafiltration filter, or microfiltration filter. In one embodiment, the membrane filter is provided in the form of a hollow-fiber membrane filter. Membrane filtration captures contaminants in a physical barrier via a size-exclusion mechanism consistent with sand, diatomaceous earth, and pleated cartridge pool and spa filter media. However, membrane filtration is capable of capturing particles above about 0.005 microns in size (or 0.005 microns in size), particularly in the range of about 0.02 microns to about 0.2 microns (or 0.02 microns to 0.2 microns).

As best shown in FIG. 3A, the inlet port 280a of FIG. 2 is connected to and in fluid communication with an internal inlet pipe 330a. The outlet port 280b of FIG. 2 is connected to and in fluid communication with an internal outlet pipe 330b. During operation, a fluid (e.g., water from the aquatic application 100) enters the hybrid filter assembly 200 through the inlet port 280a and the internal inlet pipe 330a, flows through the first filtration stage 310 and then the second filtration stage 320, and exits the hybrid filter assembly 200 through the internal outlet pipe 330b and the outlet port 280b.

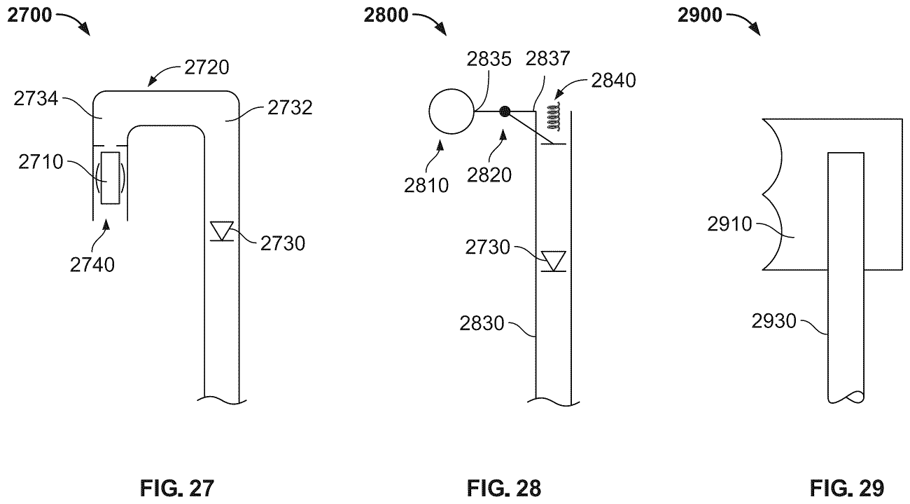

In some instances, the hybrid filter assembly 200 may also include one or more of a diffuser 340, a internal air relief valve 350, and an air bleeder tube 360. The diffuser 340 may be connected to an end of the internal inlet pipe 330a and is designed to distribute water throughout the filtration vessel 210. The internal air relief valve 350 may be provided in the form of a passive internal air relief valve, an automated internal air-bleed bypass valve, or a combination thereof, for example. The internal air relief valve 350 may be coupled to the first port 250 of FIG. 2. In some instances, the internal air relief valve 350 can be opened to allow air and/or water in a top portion of the filtration vessel 210 to escape. In other instances, the internal air relief valve 350 can be closed, enabling pressure to build up in the filtration vessel 210. When pressurized, fluid in the filtration vessel 210 may be forced to flow down to the bottom of the filtration vessel 210, out of the internal outlet pipe 330b and outlet port 280, and/or out the drain port 280c of FIG. 2. However, once the filtration vessel 210 is filled with fluid, the internal air relief valve 350 may allow untreated water to bypass the filtration media, thereby reducing the efficiency of the hybrid filter assembly 200. For example, the untreated water may flow into the internal air relief valve 350 instead of flowing through the filtration media. In this instance, it may be beneficial to provide the internal air relief valve 350 in the form of the automated internal air-bleed bypass valve. Accordingly, FIGS. 27-29 illustrate various automated internal air-bleed bypass valves contemplated for use with the hybrid filter assemblies disclosed herein.

In some instances, the automated internal air-bleed bypass valve may include a water level sensor and a shut-off valve. In some such instances, the hybrid filter assembly 200 may be provided with two bypass valves: the automated internal air-bleed bypass valve, which is in communication with the passive internal air relief valve 350 of FIG. 3A. The water level sensor may be designed to determine when air has been purged from the filtration vessel 210 and, in turn, provide feedback to the automated internal air-bleed bypass valve. In some instances, the water level sensor can be provided in the form of a mechanical float coupled to the shut-off valve, a float including a permanent magnet and a hall-effect sensor, an ultrasonic water level sensor, a capacitive touch water level sensor, and/or any other known water level sensor. The water level sensor may be positioned at any location within the filtration vessel 210. For example, the water level sensor may be positioned proximate or adjacent to the upper housing 220. As an additional example, the water level sensor may be positioned proximate or adjacent to a top portion of the upper housing 220.

In certain instances, the shut-off valve may be provided in the form of a fill valve designed to automatically close when the water level sensor (e.g., a float device) indicates the water level is at a desired level. In some instances, the shut-off valve may be provided in the form of an actuated mechanical valve, such as a ball or gate valve, and/or a solenoid in-line valve. The automated shut-off relief valve can improve the efficiency of the hybrid filter assembly 200 by automatically opening an air bypass of the shut-off valve when air needs to be purged from the filtration vessel 210 and automatically closing the air bypass after the air has been purged.

Referring to FIG. 27, an automated internal air-bleed bypass valve 2700 is provided in the form of a float 2710 positioned within a substantially J-shaped conduit 2720, although the conduit 2720 may also be provided in other shapes and forms (e.g., a U-shaped conduit). In some instances, the conduit 2720 may be the air bleeder tube 360 of FIG. 3A, although the conduit 2720 may otherwise be provided or positioned in the filtration vessel 210. As shown, the conduit 2720 may include a check valve 2730 positioned in a first portion 2732 of the conduit 2720 and the float 2710 can be positioned in a second portion 2734 of the conduit 2720.

The air-bleed bypass valve may include an open end 2740 provided in the second portion 2734 of the conduit 2720. The open end 2740 may be designed to function as an outlet for any air purged from the hybrid filter assembly 200. In certain instances, the second portion 2734 may include one or more stoppers, a lip, a ring, and/or other similar devices positioned below the float 2710 to help prevent the float 2710 from falling out of the open end 2740. In addition, one or more stoppers, a lip, a ring, and/or other similar devices can be positioned within the second portion 2734 and above the float 2710 to help prevent the float 2710 from becoming lodged or pushed too far into the conduit 2720.

When air needs to be relieved or purged from the hybrid filter assembly 200 (e.g., during filtration), the air can flow through the first portion 2732, through the check valve 2730, and through the second portion 2734. As air flows through the second portion 2734, the air can press the float 2710 downwardly, which may allow the air to flow out of the conduit 2720 via the open end 2740. However, when air is not being relieved or purged from the hybrid filter assembly 200, water may flow into the open end 2740 of the conduit 2720 and cause the float 2710 to move upwardly and seal (i.e., close) the conduit 2720. Thus, the automated internal air-bleed bypass valve 2700 may help prevent fluid from bypassing the filtration media (e.g., the granular media 315) of the hybrid filter assembly 200. In addition, the check valve 2730 may help prevent fluid provided from bypassing the first filtration stage 310 when the hybrid filter assembly 200 operates in the backwash mode.

Turning to FIG. 28, an alternative automated internal air-bleed valve 2800 is illustrated. As shown, the automated internal air-bleed bypass valve 2800 is provided in the form of a ball float 2810 coupled to an arm 2820 which is coupled to a main conduit 2830. More particularly, the ball float 2810 may be attached to a first end 2835 of the arm 2820 and a second end 2837 of the arm 2820 can be coupled to a main conduit 2830. In some instances, the main conduit 2830 can be the air bleeder tube 360 of FIG. 3A, although the main conduit 2830 may otherwise be provided or positioned in the filtration vessel 210. Similar to a fill valve, when the fluid level inside the filtration vessel 210 reaches a desired level or threshold level, the ball float 2810 may rise upwardly or float, which in turn may cause a seal 2840 positioned in the main conduit 2830 to close and prevent fluid from entering the main conduit 2830. Conversely, when the fluid level in the filtration vessel 210 is lower than the desired level or the threshold level, the ball float 2810 can drop, which in turn may cause the seal 2840 to open. Accordingly, when the seal 2840 is open, air may pass through the main conduit 2830. Similar to the automated internal air-bleed bypass valve 2700, the main conduit 2830 may include the check valve 2730. The check valve 2730 may help prevent fluid provided from bypassing the first filtration stage 310 when the hybrid filter assembly 200 operates in the backwash mode. Thus, the automated internal air-bleed bypass valve 2800 may help prevent fluid from bypassing the filtration media (e.g., the granular media 315) of the hybrid filter assembly 200.

In some instances, using an automated internal air-bleed bypass valve that does not include movable parts may be desirable. Thus, FIG. 29 illustrates an automated internal air-bleed bypass valve 2900. The automated internal air-bleed bypass valve 2900 may include a passive, air permeable, water impermeable membrane 2910. The membrane 2910 may be designed to separate water from air without using moving parts such as a float or a seal. In certain instances, the membrane 2910 can be positioned on or over an open end of the main conduit 2930 to allow for the passage of air through the main conduit 2930 while preventing water from entering into the main conduit 2930. Thus, the automated internal air-bleed bypass valve 2900 may help prevent fluid from bypassing the filtration media (e.g., the granular media 315) of the hybrid filter assembly 200. In some instances, the main conduit 2930 can be the air bleeder tube 360 of FIG. 3A, although the main conduit 2930 may otherwise be provided or positioned in the filtration vessel 210.

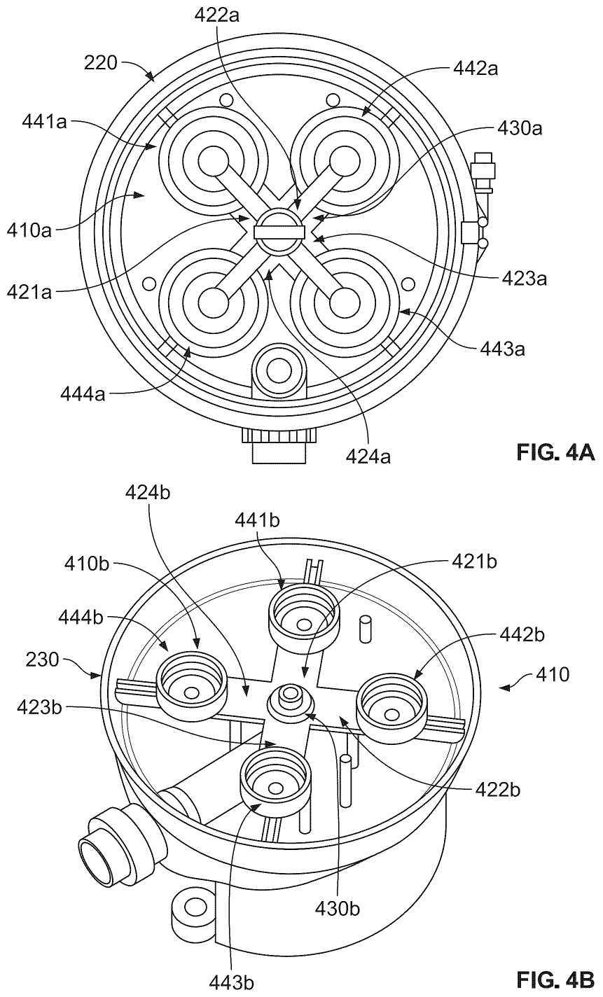

Now turning to FIGS. 4A and 4B various views of the internal components of the upper housing 220 and the lower housing 230 are shown, respectively. A manifold 410 is provided in the form of a first portion 410a and a second component 410b, each of which is disposed within the filtration vessel 210. Specifically, FIG. 4A illustrates a top-down view of the internal components of the upper housing 220 comprising a first portion 410a of a manifold 410. FIG. 4B illustrates a top isometric view of the lower housing 230 comprising a second component 410b of the manifold 410. Together, the first portion 410a and the second component 410b of the manifold 410 may secure one or more second filtration stage filter membranes in an upright configuration within the hybrid filter assembly 200 by engaging with opposing ends of the filter membranes.

As shown, each of the first portion 410a and the second component 410b of the manifold 410 comprises one or more arms extending from a center. Each of the ends of the one or more arms may include a module receiver. Referring specifically to FIG. 4A, the first portion 410a of the manifold 410 comprises four upper arms 421a-424a extending radially outwardly from an upper center region 430a and four upper module receivers 441a-444d.

The second component 410b of the manifold 410 can substantially mirror the first portion 410a. Thus, as shown in FIG. 4B, the second component 410b includes four lower arms 421b-424b extending radially outwardly from a lower center region 430b and four lower module receivers 441b-444b.

Thus, when the upper housing 220 and the lower housing 230 are coupled, a fluid circuit can be formed between the first portion 410a of the manifold 410, the second component 410b of the manifold 410, and the one or more membrane filtration modules positioned between the first portion 410a and the second component 410b of the manifold 410.

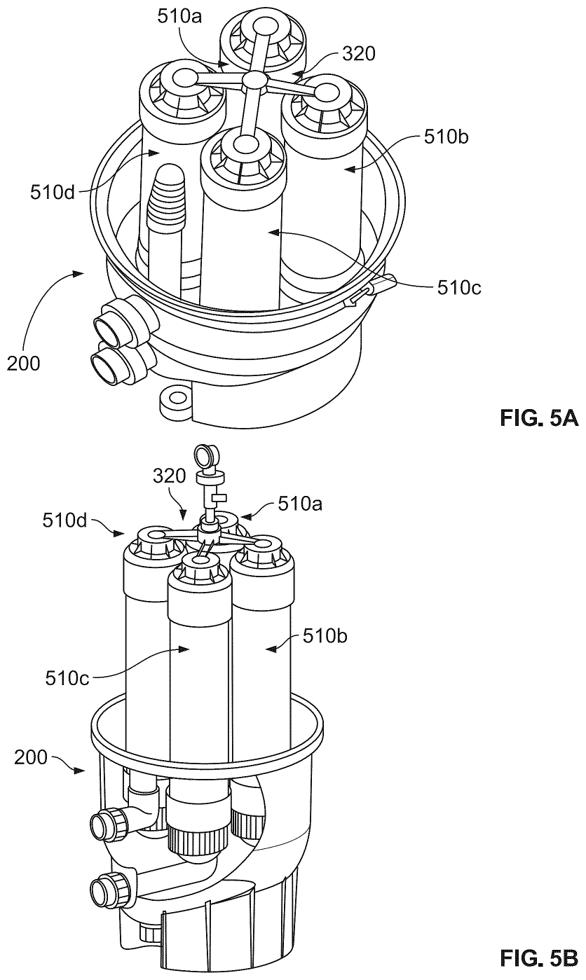

Turning to FIGS. 5A and 5B, detailed views of the second filtration stage 320 are shown. For clarity, various parts of the hybrid filter assembly 200 have been removed to show some of the internal components. Four membrane filtration modules 510a-510d of the second filtration stage 320 are positioned within the manifold 410. It is to be understood that although four membrane filtration modules 510a-510d are shown, the hybrid filter assembly 200 may contain more or fewer membrane filtration modules depending on the embodiment. For example, some embodiments contain multiple membrane filtration modules of the same type and capacity, including nominal pore size, diameter, and practical length, which are co-located within the filtration vessel 210 in a parallel array. As an additional example, other embodiments may contain a single membrane filtration module or multiple membrane filtration modules of different types, lengths, and/or diameters, employed in series and/or in parallel.

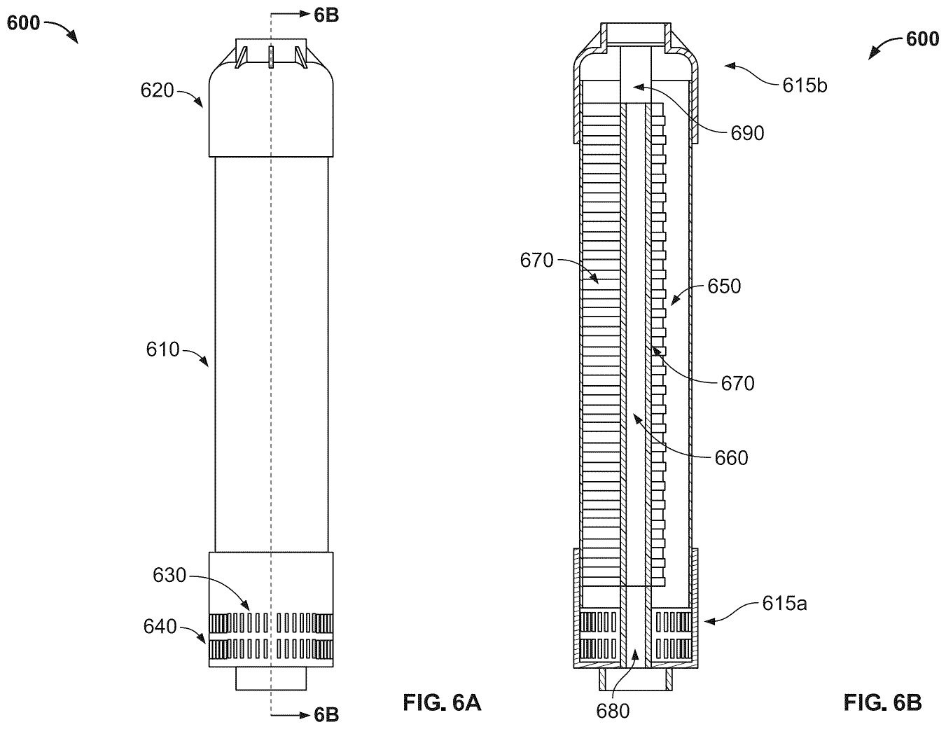

Now referring to FIGS. 6A and 6B, detailed illustrations of an exemplary single membrane filtration module 600 according to an embodiment are shown. The membrane filtration module 600 can be one or more of the membrane filtration modules 510a-510d of FIGS. 5A and 5B. As shown in FIG. 6A, the membrane filtration module 600 is provided in the form of an enclosed assembly comprising a cylindrical housing 610, a top endcap 620, and a bottom endcap 630. The top endcap 620 may be provided as a “blind” endcap that is designed to separate a module feed and a permeate flow. The top endcap 620 may further isolate the membrane filtration module 600 from unfiltered water introduced to the first filtration stage 310. In some instances, the top endcap 620 may include a plug 625 designed to form a substantially watertight seal to prevent water from entering or leaving one or more membrane filtration modules 510a-510d of the second filtration stage 320.

The bottom endcap 630 may be provided in the form of a lateral endcap. The bottom endcap 630 may further include a plurality of axial slits 640 circumscribing and extending partially or fully through the bottom endcap 630. The bottom endcap 630 is designed to help keep the media of the first filtration stage 310 separated from the media of the second filtration stage 320. Thus, in some instances, the bottom endcap 630 may include another plug (not shown) designed to form a substantially watertight seal to prevent water from entering or leaving one or more membrane filtration modules 510a-510d of the second filtration stage 320.

The axial slits 640 may be equidistantly spaced circumferentially around the bottom endcap 630 in some instances. In other aspects, the axial slits 640 may be non-uniform and/or may not extend entirely around the circumference thereof. In some forms, the axial slits 640 are imparted with a width of about 0.005 inches to about 0.02 inches (or about 0.0127 cm (centimeters) to about 0.0508 cm). In other forms, the axial slits 640 are imparted with a width of 0.005 inches to 0.02 inches (or 0.0127 cm to 0.0508 cm). In yet other forms, the axial slits 640 are imparted with a width somewhat larger or even smaller than the values recited herein. The axial slits 640 are designed to have a lateral opening that is smaller than the size of the media of the first filtration stage 310, so as to prevent the media from the first filtration stage 310 from entering the membrane filtration module 600. Additionally, the bottom endcap 630 is configured to keep the permeate and feed flow paths separate and to fluidly couple a permeate pipe of the filtration module to the filtration vessel 210 of FIG. 2.

Referring specifically to FIG. 6B, various internal components of the membrane filtration module 600 are shown. The internal components may include a membrane 650 surrounding a permeate pipe 660. Fluid can flow between the membrane 650 and the permeate pipe 660 via a plurality of axial openings 670. A module outlet 680 disposed at a first end 615a of the membrane 650 and the permeate pipe 660 can form a fluid flow path between the permeate pipe 660 and the filtration vessel 210 of FIG. 2. The membrane filtration module 600 may include a cap or plug 690 disposed at a second end 615b of the membrane filtration module 600 and the permeate pipe 660. The plug 690 can be designed to prevent fluid from flowing out the top of the membrane filtration module 600 instead of passing through the membrane 650. As shown, the plug 690 can be coupled to and/or part of the top endcap 620.

In one embodiment, the membrane filtration module 600 is defined by an asymmetric hollow fiber membrane produced from selective homopolymers or copolymers (e.g., polyethersulfone (PES) and polyvinylpyrrolidone (PVP) polymers). In other instances, the hollow fiber membranes may be formed of a blend of polymers such as, by way of example, a blend PES and PVP polymers or a blend of PES, PEV, and polyethylene glycol (PEG) polymers. In some instances, the hollow fibers deposited in an interior of the membrane filtration module 600 may be imparted with a surface area of at least about 20 square meters to at least about 30 square meters, although the surface area of the hollow fibers deposited within the interior of the membrane filtration module 600 may be somewhat less or even greater than these values. In other embodiments, the membrane filtration module 600 can be provided in a symmetric type with uniform pore structure, or as a layer deposited onto a structural core. In some instances, the membrane filtration module 600 can be produced from silicon carbide ceramic having a controlled crystalline or lattice structure.

In some forms, the membrane filtration modules 600 are ultrafiltration membranes imparted with a nominal pore size of about 10 to about 50 nanometers, or more particularly, about 20 to about 40 nanometers, and imparted with a lumen diameter of about 0.25 millimeters to about 2.5 millimeters. In other forms, the membrane filtration modules 600 are ultrafiltration membranes imparted with a nominal pore size of 10 to 50 nanometers, or more particularly, 20 to 40 nanometers, and imparted with a lumen diameter of 0.25 millimeters to 2.5 millimeters. In yet other forms, the membrane filtration modules 600 are ultrafiltration membranes imparted with a nominal pore size and lumen diameter that are larger or smaller than the values recited herein. The ultrafiltration membranes may be operated in a dead-end, inside-out deposition mode, and fouling recovery is achieved through backwashing via flux reversal. In other embodiments, the membrane filtration module 600 may be provided in the form of microfiltration membranes imparted a nominal pore size of about 50 nanometers to about 1,500 nanometers (or 50 nanometers to 1,500 nanometers), although the pore size of the microfiltration membranes may be larger or smaller than these values. In yet other embodiments, the membrane filtration module 600 may include fibers imparted with a lumen diameter of about 0.3 millimeters to about 3 millimeters (or 0.3 millimeters to 3 millimeters). Depending on the instance, it may be preferable to utilize fibers with a lumen diameter imparted with a value of about 0.5 millimeters to about 2 millimeters (or 0.5 millimeters to about 2 millimeters). In some instances, the membrane filtration modules 600 are imparted with a molecular weight cut-off (MWCO) value of about 150 kilodaltons to about 200 kilodaltons (or 150 kilodaltons to 200 kilodaltons), although the MWCU value may be less than or greater than these values. In other instances, the membrane filtration modules 600 may be imparted with a MWCU value such that the membrane filtration modules 600 are designed to retain silt, bacteria, viruses, and/or other particles that reduce water clarity and water quality. In some embodiments, the membrane filtration modules 600 can be operated using an outside-in deposition mode, and/or the fibers of the membrane filtration modules 600 can be provided in a randomized arrangement or by including helically wound fibers.

In some instances, the membrane filtration module 600 may be imparted with chemical resistance properties. For example, the membrane filtration module 600 may be imparted with acid-resistant properties, base-resistant properties, and/or chlorine-resistant properties. In certain instances, the membrane filtration module 600 may not degrade under high- or low-pH conditions, e.g., the membrane filtration module 600 may be designed to operate without significant degradation when processing fluid imparted with a pH value of about 2 to about 12 (or a pH value of 2 to 12). As an additional example, the membrane filtration module 600 may be designed to operate without significant degradation when processing fluid imparted with a free chlorine value of no more than about 500 milligrams per liter (or no more than 500 milligrams per liter). In certain instances, the membrane filtration module 600 may be designed to operate without significant degradation when the water supplied to the membrane filtration module 600 is imparted with a pH value somewhat lower or higher than the values recited herein. In certain other instances, the membrane filtration module 600 may be designed to operate without significant degradation when the water supplied to the membrane filtration module 600 is imparted with a free chlorine value even greater than the values recited herein. Thus, in certain instances, the membrane filtration module 600 may resist degradation by the chemicals provided to the membrane filtration module 600 during the chemical cleaning process.

In certain instances, the membrane filtration module 600 may be provided as a Pentair X-Flow XF53 Membrane Element manufactured by X-Flow B.V. of the Netherlands.

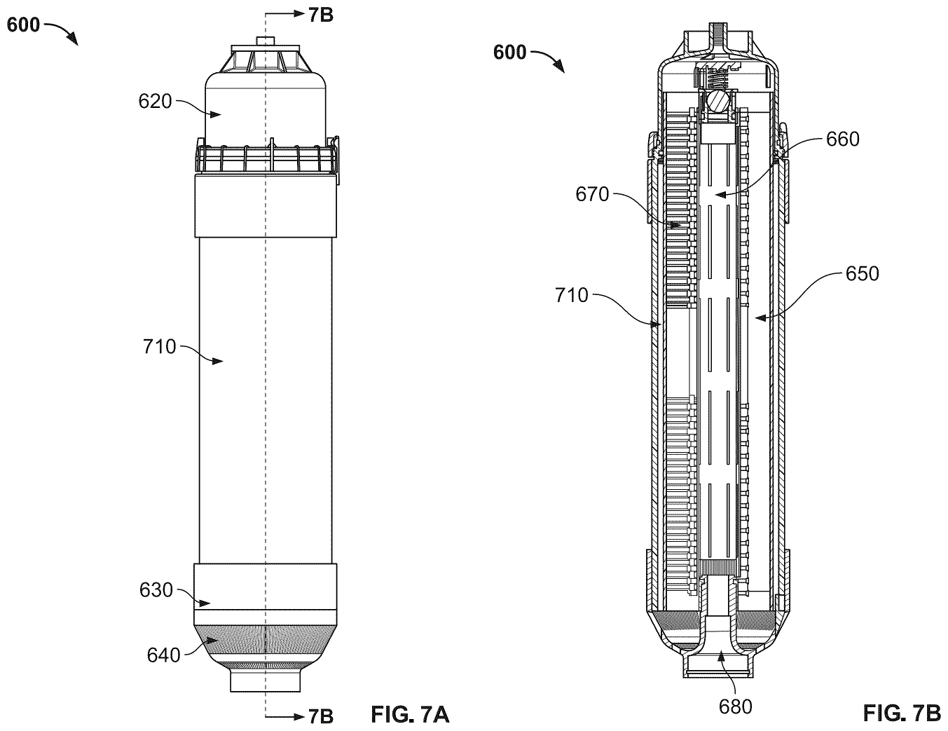

FIGS. 7A and 7B illustrate a membrane filtration module 700 according to another embodiment. The membrane filtration module 700 is similar to the membrane filtration module 600 of FIGS. 6A and 6B. However, the housing 610 is provided in the form of a solid guard 710. Similar to the cylindrical housing 610 of FIGS. 6A and 6B, the guard 710 can extend between and be coupled to the top endcap 620 and the bottom endcap 630. Thus, the guard 710 can substantially or entirely surround the internal components of the membrane filtration module.

The guard 710 is designed to provide separation between the first filtration stage (e.g., the porous media) 310 and the second filtration stage 320. Therefore, it can be easier to install and service the hybrid filter assembly 200 because an interior portion of the membrane filtration module 700 (i.e., the internal components) can be slidably removed without removing the guard 710. For example, the top endcap 620 can be detached from the membrane filtration module 700 and the internal components of the module can be removed upwardly therefrom. The membrane filtration module 700 can then be serviced or replaced without disturbing the first filtration stage 310. Once a maintenance or other operation is complete, the interior portion of the membrane filtration module 700 may be replaced and the top endcap 620 secured.

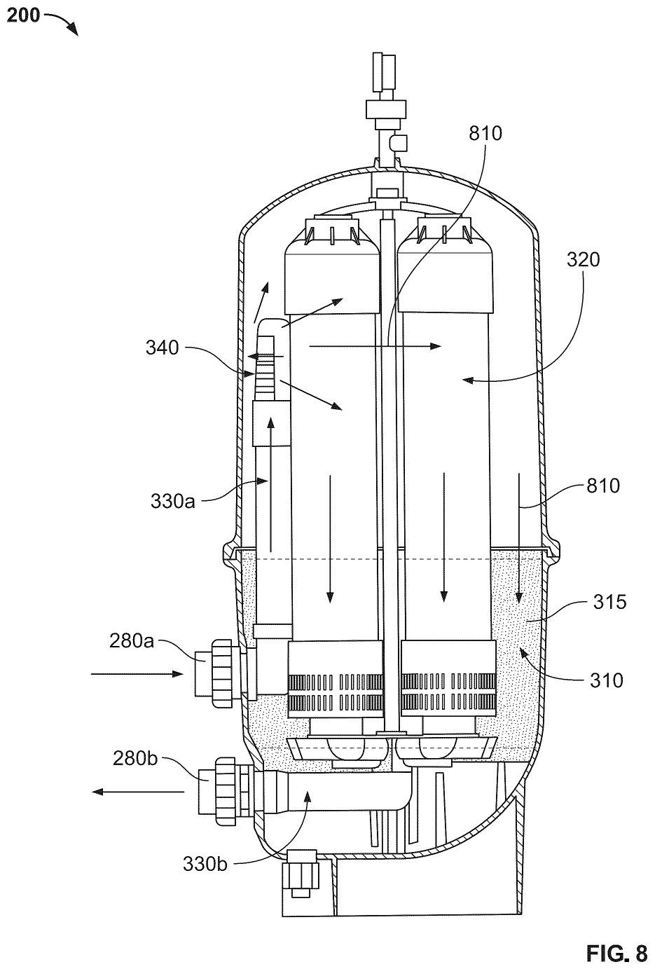

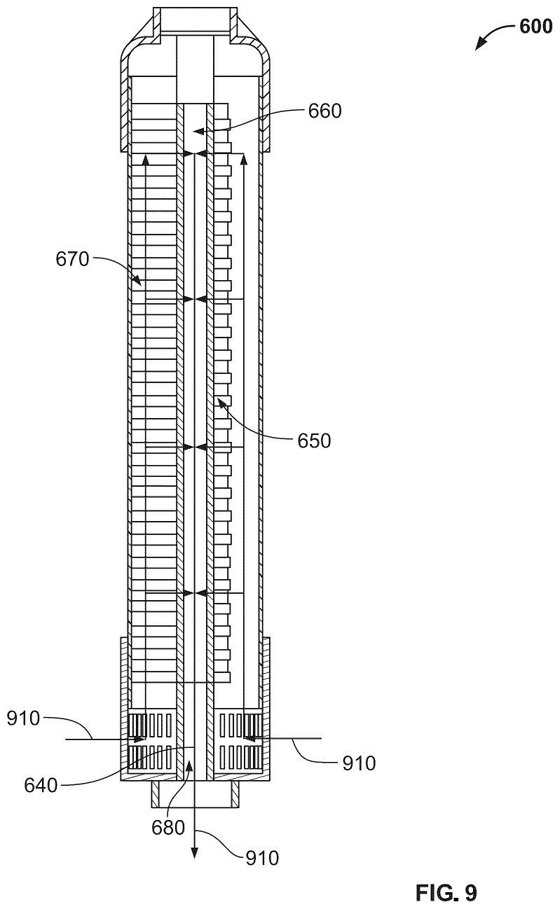

Turning to FIGS. 8-11, a fluid flow path of water through the hybrid filter assembly 200 is depicted and described. FIGS. 8 and 9 illustrate a fluid flow path through the hybrid filter assembly 200 during a filtration operation or mode. Referring first to FIG. 8, a first flow path 810 of a fluid passing through the first filtration stage 310 is shown. During the filtration mode, fluid enters the hybrid filter assembly 200 through the inlet port 280a and the internal inlet pipe 330a. The directed fluid is then distributed throughout the top of the hybrid filter assembly 200 via the diffuser 340. The fluid flows downward and through the first filtration stage 310, which captures large particles.

Next, referring to FIG. 9, the fluid flows into the second filtration stage 320 through one or more of the axial slits 640 of one or more of the membrane filtration modules 600 as shown by a second fluid flow path 910. The fluid flows upwards through the membrane 650 and into the permeate pipe 660 through the axial openings 670. The membrane 650 captures submicron particles, bacteria, and viruses in the fluid. The clean permeate fluid is then directed downward through the permeate pipe 660, and out of the membrane filtration module 600 via the module outlet 680. The module outlet 680 is in fluid communication with the internal outlet pipe 330b such that the clean water exits the hybrid filter assembly 200 through the internal outlet pipe 330b and the outlet port 280b. One or more of the membrane filtration modules 600 may be utilized during the filtration operation. Over time, the first filtration stage 310 and the second filtration stage 320 may lose efficiency due to the fouling of the filters. Thus, one or more of the first filtration stage 310 and the second filtration stage 320 can be backwashed to remove the contaminants to at least partially restore the efficiency of the hybrid filter assembly 200.

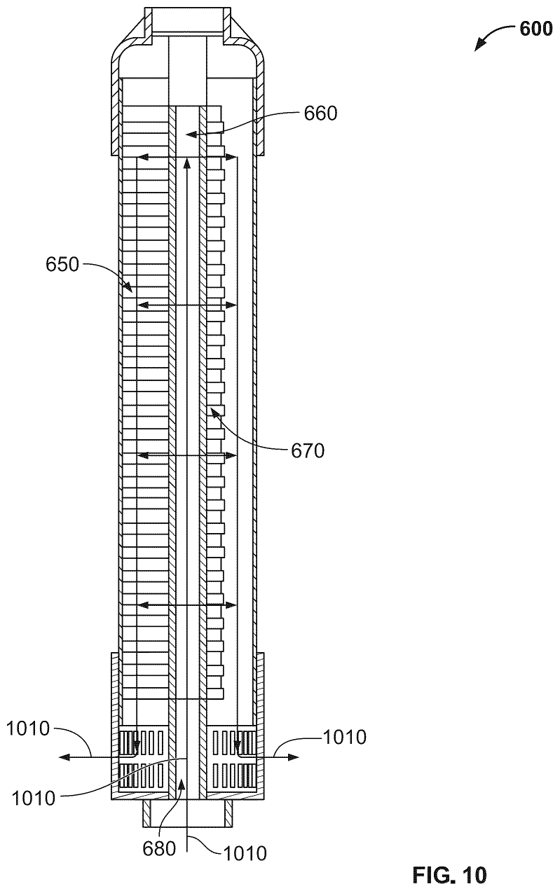

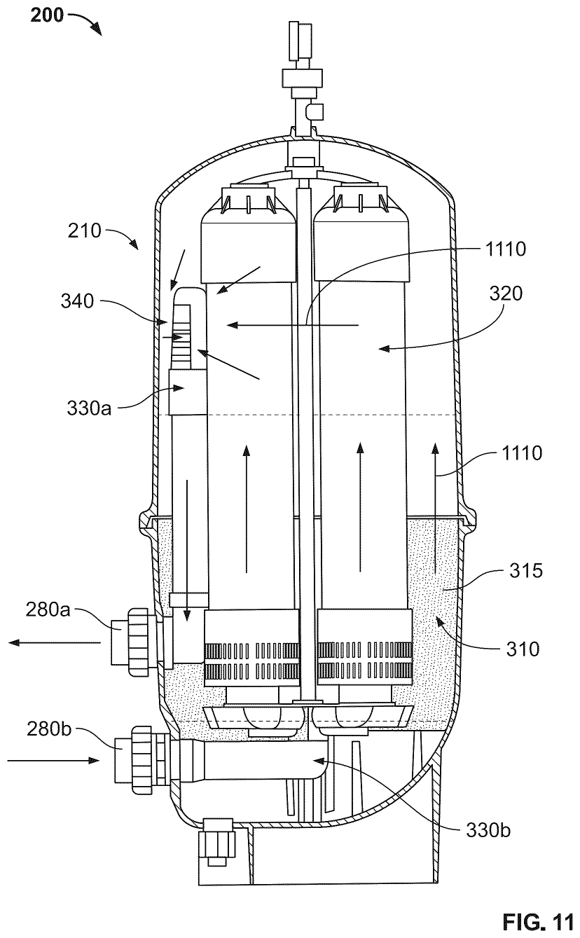

FIGS. 10 and 11 illustrate a fluid flow path through the hybrid filter assembly 200 during a backwash operation or mode. For backwashing, the fluid flow is reversed with respect to the filtration mode as described above. Thus, the particles that have previously been captured by the first filtration stage 310 and the second filtration stage 320 can be removed from the hybrid filter assembly 200 in unison. When the backwash operation is activated, water is pumped or otherwise passed into the hybrid filter assembly 200 through the outlet port 280b and the internal outlet pipe 330b and upwardly through the membrane filtration module 600 via the module outlet 680. As shown by a third fluid flow path 1010, the water flows through the permeate pipe 660, out of the axial openings 670, through the membrane 650, and out of the module outlet 680.

Next, referring to FIG. 11, the water from the module outlet 680 of the second filtration stage 320 is directed back through the first filtration stage 310. As shown by a fourth fluid flow path 1110, the water flows up through the media of the first filtration stage 310, into the diffuser 340, down through the internal inlet pipe 330a, and out of the filtration vessel 210 via the inlet port 280a. When the first filtration stage 310 is backwashed with sufficient velocity, the media lifts and disperses, allowing-the trapped particulates to flow out of the media volume. Thus, particles that were captured by the first and the second stages of filtration are removed during a single pass. By backwashing the hybrid filter assembly 200, the efficiency of the first filtration stage 310 and the second filtration stage 320 can be maintained, thereby extending the life of the hybrid filter assembly 200.

Referring back to FIG. 6B, some conventional membranes may include a plug 690 to prevent fluid from flowing out the top of the membrane. However, this plug can create an area of low or no flow in the top portion (i.e., the second end 615b) of the membrane filtration module 600 during backwashing. Thus, the second end 615b of the membrane filtration module 600 may not be effectively cleaned during the backwash procedure because little to no water may reach that portion of the membrane module. Thus, the following embodiments illustrate a check valve assembly for improving flow through the top portion of the membrane module.

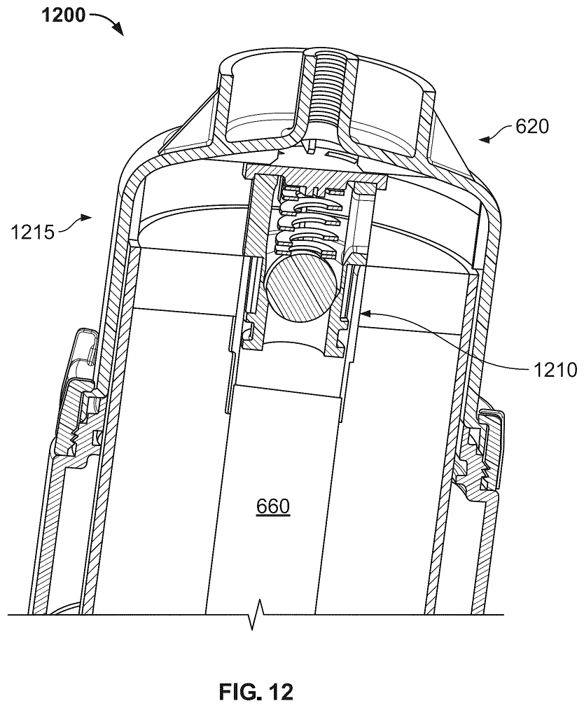

Now turning to FIG. 12, a membrane filtration module 1200 including a check valve assembly is provided. The membrane filtration module 1200 is similar to the membrane filtration module 600 of FIGS. 6A and 6B. However, the membrane filtration module 1200 includes a check valve assembly 1210 disposed in a top portion 1215 of the membrane filtration module 1200 instead of the plug 690 shown in FIG. 6B. As shown, the check valve assembly 1210 can be coupled to, or be part of, the top endcap 620. A portion of the check valve assembly 1210 can extend down into the body of the membrane filtration module 1200 and form a fluid flow path between the permeate pipe 660 and the membrane 650.

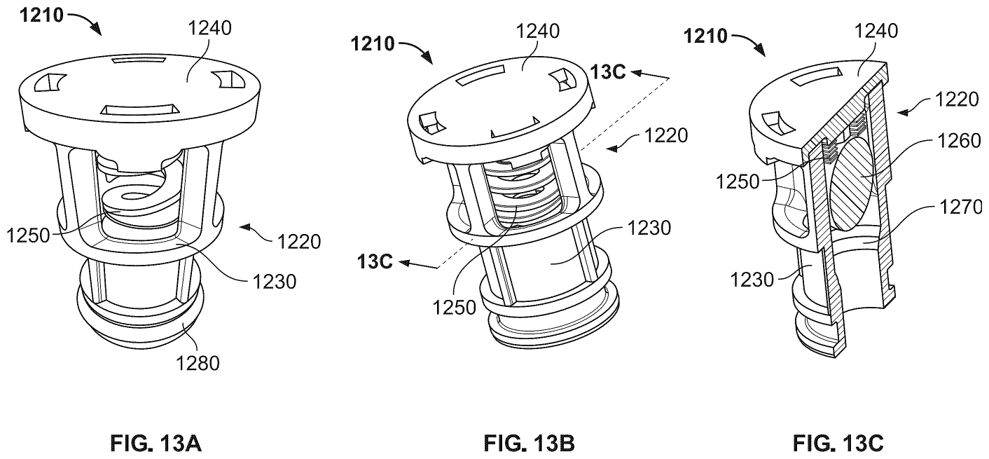

FIGS. 13A-13C illustrate various views of the check valve assembly 1210. In some instances, the check valve assembly 1210 can be provided in the form of a ball check valve, although other types of check valves may also be used. The check valve assembly 1210 may include an elongated body 1220 defined by a check valve retainer portion 1230 and a removable check valve cap 1240. The check valve retainer portion 1230 can surround and at least partially enclose a spring 1250 and a ball 1260. As best shown in FIG. 13C, the check valve retainer portion 1230 may include a seat 1270 designed to prevent downward motion of the ball 1260 when the check valve assembly 1210 is in a closed position. The check valve cap 1240 can be coupled to the check valve retainer portion 1230 and the spring 1250. The check valve cap 1240 may prevent the spring 1250 from exiting the check valve assembly 1210 when an upwardly directed force is applied to the spring 1250 (e.g., by the ball 1260). In some instances, the ball 1260 may be provided in the form of a rubber ball. In other instances, the ball 1260 may be provided in the form of a metal ball with a rubber coating. In some forms, the rubber may be provided in the form of a chemical resistant coating (e.g., Neoprene, Viton, etc.). In some instances, the spring 1250 may be provided in the form of a metal spring (e.g., stainless steel). In other instances, the spring 1250 may be provided in the form of a plastic spring.

Referring to FIG. 13A, in some instances, the check valve retainer portion 1230 may include a gasket, such as an O-ring 1280. As discussed above with reference to FIG. 12, at least a portion of the check valve retainer portion 1230 can extend into the membrane filtration module 1200 and contact the permeate pipe 660. Thus, the O-ring 1280 can form a seal between the check valve assembly 1210 and the permeate pipe 660.

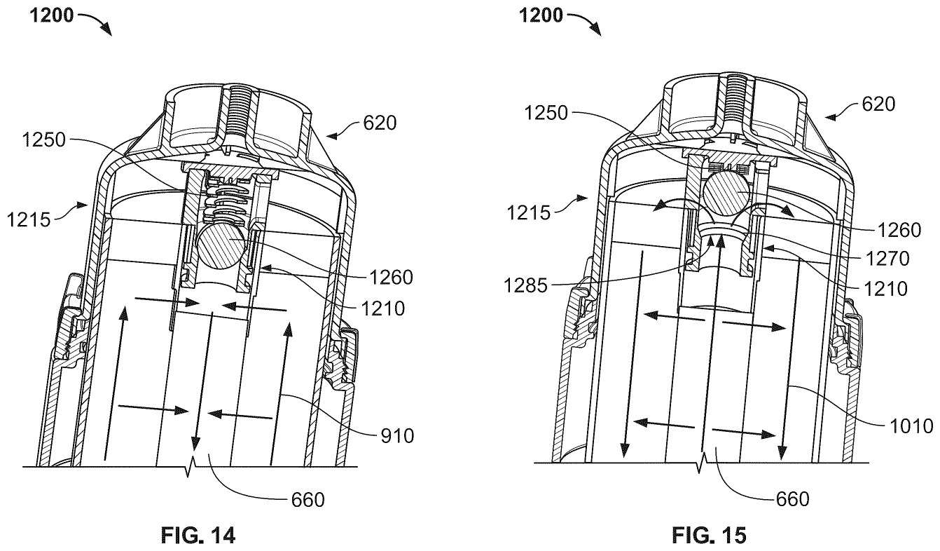

Now referring to FIGS. 14 and 15, the positions of the check valve assembly 1210 during different operational modes of the hybrid filter assembly 200 is shown. Referring first to FIG. 14, the arrangement of the check valve assembly 1210 when the hybrid filter assembly 200 is in the filtration mode is illustrated. During the filtration mode, the check valve assembly 1210 is in a closed position. When the check valve assembly 1210 is in the closed position, the spring 1250 may apply a downward force on the ball 1260, thereby positioning the ball 1260 into a seat 1270 (see FIG. 15). When the check valve assembly 1210 is closed, an opening 1285 (see FIG. 15) provided in the seat 1270 may be blocked or sealed by the ball 1260, thereby substantially or completely preventing fluid from entering the check valve assembly 1210. When the hybrid filter assembly 200 operates in the filtration mode, as discussed above with reference to FIG. 9 and shown by the second fluid flow path 910, fluid flows upwardly through the membrane 650 and into the permeate pipe 660. Thus, when arranged in the closed configuration, the check valve assembly 1210 can stop fluid from entering the top endcap 620.

When the hybrid filter assembly 200 operates in the backwash mode, it may be beneficial to permit the fluid to flow to the top portion 1215 of the membrane filtration module 1200. Thus, as shown in FIG. 15, the check valve assembly 1210 may be in an open position when the hybrid filter assembly 200 operates in the backwash mode. During the backwash mode, as discussed in FIG. 10 and shown by the third fluid flow path 1010, fluid flows up through the permeate pipe 660. As the fluid flows up through the permeate pipe 660, some of the fluid can apply an upward force on the ball 1260, which may compress the spring 1250. Thus, the ball 1260 can rise off the seat 1270 and permit the fluid to flow into the top portion 1215 of the membrane filtration module 1200. Accordingly, a benefit of the check valve assembly 1210 is that the top portion 1215 of the membrane filtration module 1200 can be cleaned during the backwash mode. Further, as described with reference to FIG. 14, the check valve assembly 1210 can prevent fluid from flowing into the top endcap 620 during the filtration mode.

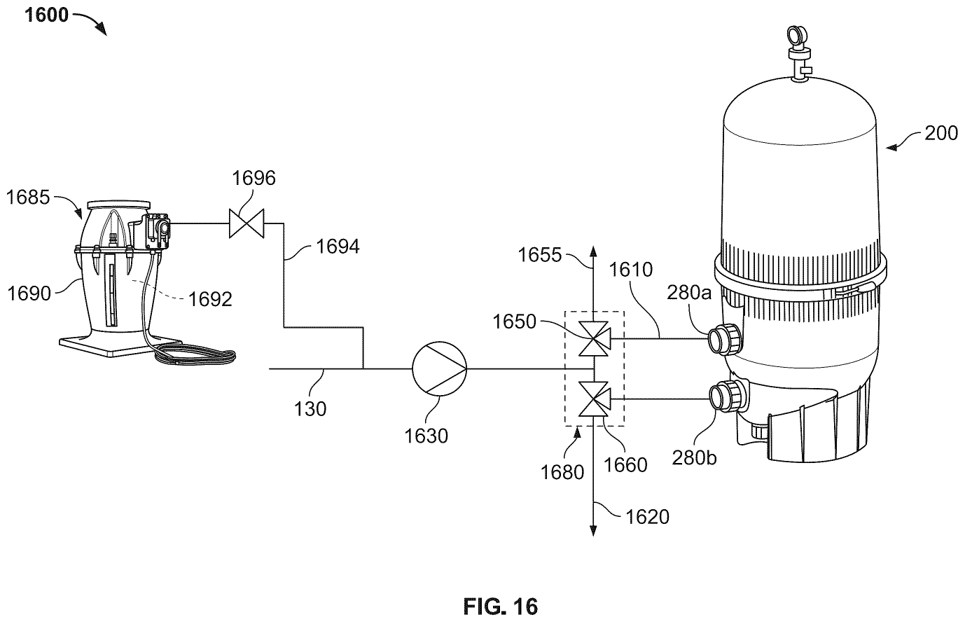

However, it can still be difficult for a user to carry out a backwash operation because the user may need to manipulate the orientation of multiple valves before, during, and after the backwash operation. Thus, FIGS. 16-25 illustrate various systems and methods for automating a backwash operation.

Referring first to FIG. 16, a first embodiment of a hybrid filter valving assembly 1600 is illustrated. The hybrid filter valving assembly 1600 may include an inlet line 1610 fluidly coupled to the inlet port 280a and an outlet line 1620 fluidly coupled to the outlet port 280b. The inlet line 1610 can correspond to and/or be the inlet conduit 130 of FIG. 1 or in fluid communication with the inlet conduit 130. The outlet line 1620 can correspond to and/or be one of the discharge conduits 140a-140c of FIG. 1 or in fluid communication with one or more of the discharge conduits 140a-140c. The outlet line 1620 may deliver the fluid processed by the hybrid filter assembly 200 to the downstream components of the aquatic application 100 of FIG. 1.

Referring again to FIG. 16, the hybrid filter valving assembly 1600 may include a pump 1630 fluidly coupled to the inlet line 1610 and/or the outlet line 1620. The pump 1630 can be designed to control the fluid flow between the hybrid filter assembly 200 and the swimming pool 110 (e.g., the flow from the inlet conduit 130). Thus, in some instances, the pump 1630 can be the variable speed pump 122 and/or the booster pump 123 of FIG. 1.

As discussed above, during one or more operational states of the hybrid filter assembly 200 (e.g., a backwash procedure), the flow of fluid through the hybrid filter assembly 200 is reversed. Thus, the hybrid filter valving assembly 1600 may include various valves to control the flow of fluid through the hybrid filter assembly 200. As shown, the inlet line 1610 may include or be in fluid communication with a first three-way valve 1650, while the outlet line 1620 may include or be in fluid communication with a second three-way valve 1660. The first three-way valve 1650 can control the flow of fluid into the hybrid filter assembly 200 via the inlet port 280a and/or the flow of fluid to a waste line 1655. The second three-way valve 1660 can control the flow of fluid out of the hybrid filter assembly 200 via the outlet port 280b and/or the flow of fluid to the outlet line 1620.

The first and second three-way valves 1650, 1660 may be oriented or actuated such that the flow of fluid to and from the hybrid filter assembly 200 can be changed, depending on the operational mode of the hybrid filter assembly 200. For example, during a filtration operation, the first three-way valve 1650 can be oriented or actuated such that fluid from the swimming pool 110 flows to the hybrid filter assembly 200 via the inlet line 1610 and the inlet port 280a, through the hybrid filter assembly 200, and back to the swimming pool 110 via the outlet port 280b and the outlet line 1620. However, during a backwash operation, the second three-way valve 1660 can be oriented or actuated such that fluid flows into the hybrid filter assembly 200 via the outlet line 1620 and the outlet port 280b, through the hybrid filter assembly 200, and out through the inlet port 280a and out through the waste line 1655.

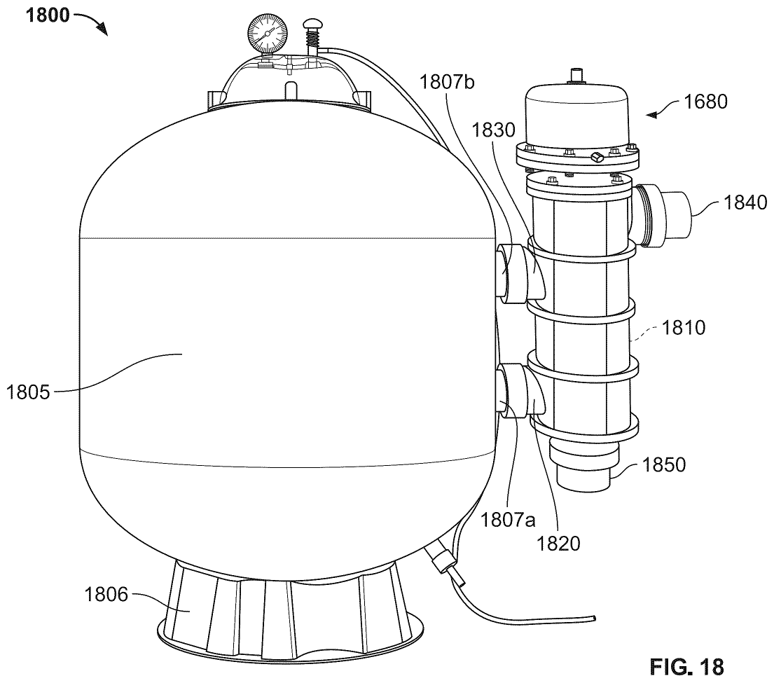

Accordingly, the orientation of the first three-way valve 1650 and the second three-way valve 1660 may be changed each time the hybrid filter assembly 200 is switched between the filtration mode and the backwash mode (and vice versa). Therefore, it may be beneficial to simplify and/or automate the hybrid filter valving assembly 1600 so that it is faster and easier for a user to change from one operational mode to another. Thus, a backwash valve assembly 1680 can replace both the first three-way valve 1650 and the second three-way valve 1660. FIGS. 18-21 and 25 illustrate views of particular instances of the backwash valve assembly 1680.

Moreover, the backwash valve assembly 1680 may be utilized in a variety of hybrid filter valving assemblies. Still referring to FIG. 16, in some instances, the hybrid filter valving assembly 1600 may include a chemical cleaning system 1685. The chemical cleaning system 1685 may be provided in the form of a chemical feed tank 1690 designed to retain a chemical cleaning agent 1692 and a chemical feed line 1694 designed to place the chemical feed tank in fluid communication with the hybrid filter assembly 200. For example, the chemical feed tank 1690 can be fluidly coupled to the hybrid filter assembly 200 by tying the chemical feed line 1694 into the inlet conduit 130. Alternatively, the chemical feed line 1694 may also be tied into or coupled to other components of the hybrid filter assembly 200.

The chemical cleaning agent 1692 used to clean the hybrid filter assembly 200 may be provided in the form of chlorine, bromine, calcium hypochlorite, trichloroisocyanuric acid, dichloro-s-triazinetrione, other cleaning or bleaching agents, and combinations thereof. For example, the chemical cleaning agent may be selected from the group consisting of a chlorine-containing compound, a chlorine-containing solution, a bromine-containing compound, a bromine-containing solution, a bleaching agent, an acidic solution, and combinations thereof. In some such instances, the chemical cleaning agent may be selected from the group consisting of calcium hypochlorite, trichloroisocyanuric acid, dichloro-s-triazinetrione, and combinations thereof.

In some instances, the chemical feed line 1694 may include or be in fluid communication with a two-way valve 1696. The two-way valve 1696 may be designed to control the flow of the chemical cleaning agent 1692 from the chemical feed tank 1690 to the hybrid filter assembly 200. For example, during a normal filtration operation, the two-way valve 1696 may be closed so to help prevent the pump 1630 from pulling the chemical cleaning agent 1692 into the hybrid filter assembly 200. However, during a cleaning operation (i.e., when the hybrid filter assembly 200 operates in the chemical cleaning mode), the two-way valve 1696 can be oriented or actuated into an open configuration to allow the chemical cleaning agent 1692 to flow through the chemical feed line 1694 and to the hybrid filter assembly 200.

A benefit of including the backwash valve assembly 1680 when the chemical cleaning system 1685 is provided is that the backwash valve assembly 1680 can simplify the chemical cleaning process. More particularly, the backwash valve assembly 1680 may facilitate easier conversion of the hybrid filter assembly 200 from the filtration mode to the backwash mode (and vice versa) during the chemical cleaning process.

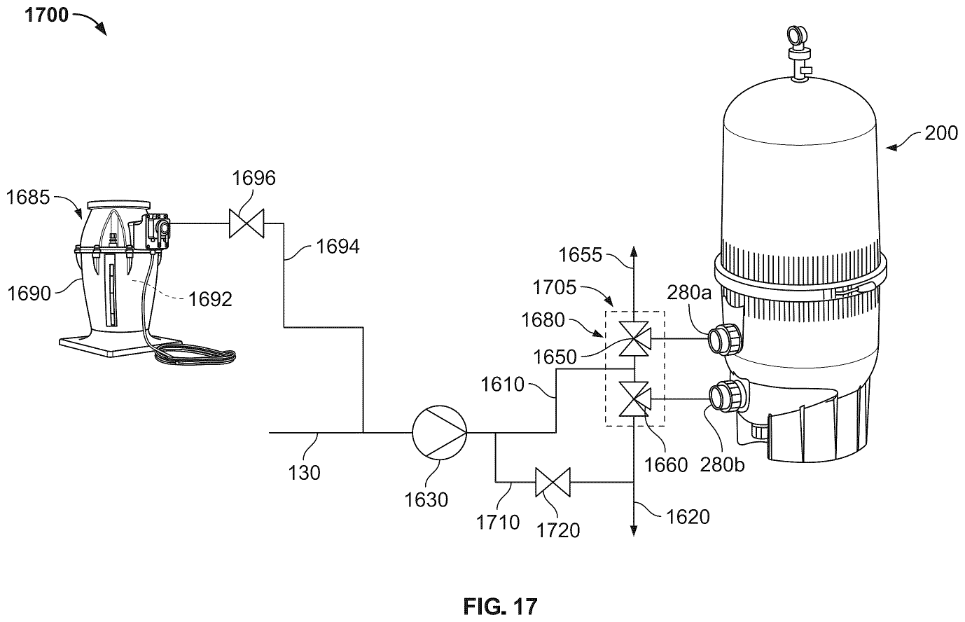

FIG. 17 illustrates yet another example of a hybrid filter valving assembly 1700 including the backwash valve assembly 1680 and the chemical cleaning system 1685. The hybrid filter valving assembly 1700 is similar to the hybrid filter valving assembly 1600 of FIG. 16. However, in the hybrid filter valving assembly 1700, a bypass line 1710 may be provided. The bypass line 1710 may tie into the inlet line 1610 downstream of the discharge of the pump 1630 and may also tie into the outlet line 1620 downstream of the second three-way valve 1660. The bypass line 1710 may include a second two-way valve 1720 between the tie-ins for the inlet line 1610 and the outlet line 1620. Thus, the bypass line 1710 may provide a path for a fluid to bypass the hybrid filter assembly 200 and/or at least one of the first and second filtration stages 310, 320 of the hybrid filter assembly 200.

It is to be understood that the backwash valve assembly 1680 may be included in a variety of hybrid filter valving assemblies and chemical cleaning systems. For instance, a detailed discussion of various hybrid filter valving assemblies and chemical cleaning systems can be found in U.S. patent application Ser. Nos. 18/936,550 and 18/936,822, each entitled “Hybrid Filter and Chemical Cleaning Assembly and Method” and filed on Nov. 4, 2024, the contents of which are incorporated herein by reference in their entirety.

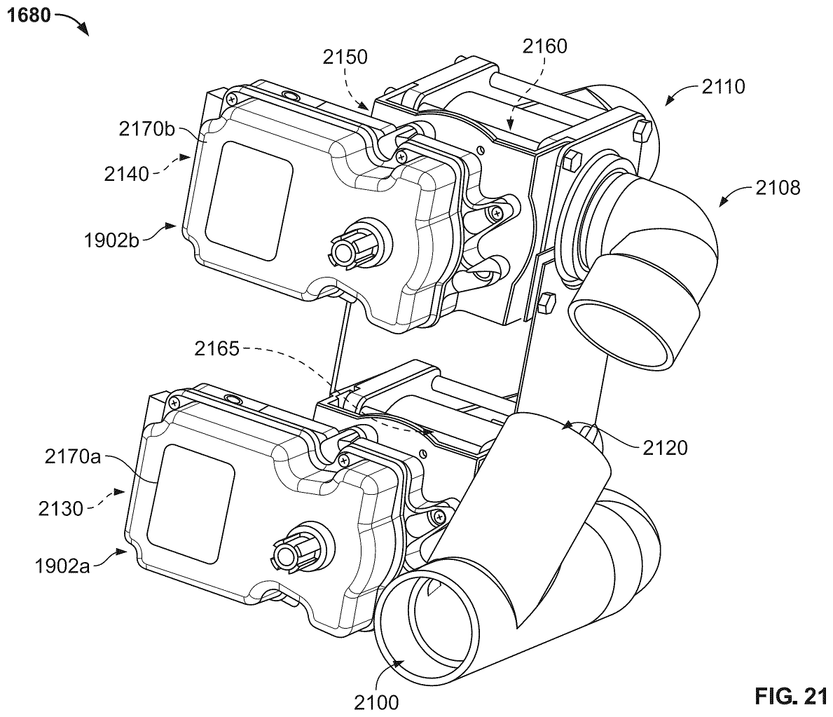

Turning to FIGS. 18-25, various implementations of the backwash valve assembly 1680 are illustrated. Turning first to FIG. 18, the backwash valve assembly 1680 is coupled to a vessel 1805 provided in the form of a cylindrical body coupled to a base 1806, although the vessel 1805 may also be provided in other shapes and forms. Like the filtration vessel 210 illustrated in FIG. 2, the vessel 1805 may include an inlet port 1807a and an outlet port 1807b designed to place the vessel 1805 into fluid communication with the aquatic application 100. The backwash valve assembly 1680 may be provided with various fluid line connections designed to place the vessel 1805 in fluid communication with the aquatic application 100, as further described with reference to FIG. 21. For example, the backwash valve assembly may be provided in the form of a feed line connection 1810, a filter inlet connection 1820, a filter outlet connection 1830, a pool return line connection 1840, and a waste line connection 1850. In some instances, the feed line connection 1810 may be designed to fluidly coupled to the inlet conduit 130 of FIG. 1. In certain instances, the filter inlet connection 1820 is fluidly coupled to the inlet port 280a. In some cases, the filter outlet connection 1830 is fluidly coupled to the outlet port 280b. In certain cases, the pool return line connection 1840 is fluidly coupled to one or more of the discharge conduits 140a-140c of FIG. 1. In some instances, the waste line connection 1850 is fluidly coupled to a waste system and/or is allowed to drain to the environment.

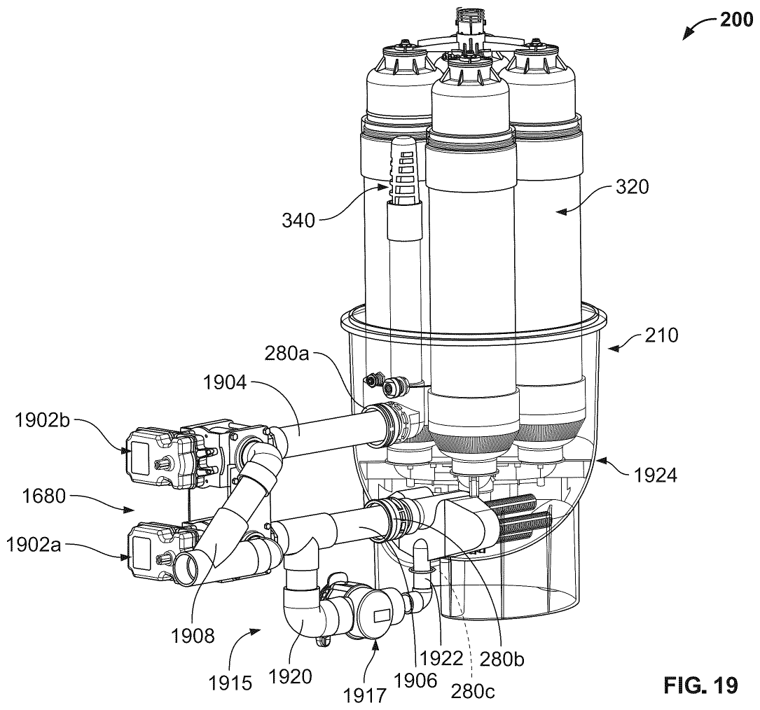

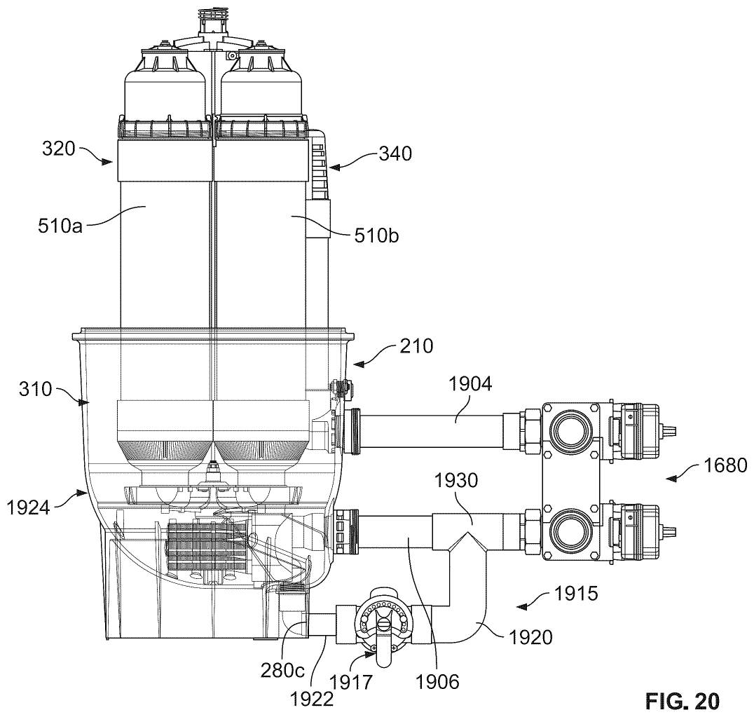

Turning next to FIGS. 19-24, another implementation of a backwash valve assembly (e.g., the backwash valve assembly 1680) is provided. As shown in FIGS. 19 and 20, the backwash valve assembly 1680 is coupled to the hybrid filter assembly 200 described with reference to FIG. 2. In this instance, the backwash valve assembly 1680 is provided in the form of a first backwash valve 1902a, a second backwash valve 1902b, an inlet conduit 1904, an outlet conduit 1906, and a valve conduit 1908. The inlet conduit 1904 may be coupled to or in fluid communication with the inlet port 280a of the hybrid filter assembly 200, and the outlet conduit 1906 may be coupled to or in fluid communication with the outlet port 280b of the hybrid filter assembly 200. The valve conduit 1908 may fluidly couple the first and second backwash valves 1902a, 1902b. In addition, the valve conduit 1908 may be in fluid communication with the swimming pool 110 and the pump 123 of FIG. 1. The backwash valve assembly may also be in fluid communication with a bypass assembly 1915, described in more detail below. Each of the first and second backwash valves 1902a, 1902b, along with components of the bypass assembly 1915, may be in electronic communication with the central controller 150 of FIG. 1. For example, the central controller 150 may direct actuation of the first and second backwash valves 1902a, 1902b, the components of the bypass assembly 1915, and/or other components of the hybrid filter assembly 200 such that the hybrid filter assembly 200 enters the bypass mode, the backwash mode, or another operational mode.

Referring again to FIGS. 19 and 20, the second backwash valve 1902b may be coupled to or in fluid communication with the inlet conduit 1904 and the valve conduit 1908. In certain instances, when the hybrid filter assembly 200 operates in a bypass mode in which both the first and second filtration stages 310, 320 are bypassed, the central controller 150 may actuate the second backwash valve 1902b to prevent fluid from the swimming pool 110 of FIG. 1 from flowing into the inlet port 280a. Instead, the fluid may enter the valve conduit 1908, be directed to the first backwash valve 1902a and/or the second backwash valve 1902b, and be recirculated back to the swimming pool or spa 110. This bypass mode may be activated, for example, when at least one of the first and second filtration stages 310, 320 undergoes a chemical soaking or cleaning process. Alternatively, when only the second filtration stage 320 is bypassed, the central controller 150 may direct actuation of the bypass assembly 1915 to substantially prevent a flow of fluid into the second filtration stage 320.

In certain instances, the backwash valve assembly 1680 may be in fluid communication with the bypass assembly 1915. The bypass assembly 1915 may be designed to selectively allow fluid to flow into and out of the filtration vessel 210 via the drain port 280c. The bypass assembly may be provided in the form of a bypass valve 1917 that is coupled to a first bypass conduit 1920 and a second bypass conduit 1922. The bypass valve 1917 may be provided in the form of a two-way valve, a three-way valve, a six-way valve, or other similar valves designed to control the flow of fluid. In certain instances, the bypass valve 1917 may be provided in the form of a solenoid valve, a pneumatic valve, or any other mechanically or electrically actuatable valve. In such instances, the bypass valve 1917 may be in electronic communication with the central controller 150 and/or a local controller provided with the hybrid filter assembly 200 or another pool component 102 (see FIG. 1). In certain instances, the bypass valve 1917 may be a manually actuatable valve.

The first and second bypass conduits 1920, 1922 may be designed to place the bypass assembly 1915 in fluid communication with the filtration vessel 210 and the outlet conduit 1906, although the first and second bypass conduits 1920, 1922 may also be in fluid communication with other conduits associated with the hybrid filter assembly 200 (e.g., a waste conduit, the inlet conduit 1904). In some instances, the bypass valve 1917 may be integrally formed with the first and second bypass conduits 1920, 1922. In other instances, the first and second bypass conduits 1920, 1922 may be provided as a single conduit.

In some instances, the second bypass conduit 1922 may be coupled to the drain port 280c. Alternatively, the second bypass conduit 1922 may be coupled to or in fluid communication with an additional port provided in a bottom portion 1924 of the filtration vessel 210. The additional port may be designed to place the first filtration stage 310 into fluid communication with components of the hybrid filter assembly 200 positioned outside of the filtration vessel 210 and/or one or more of the pool components 102 of FIG. 1. Like the drain port 280c, the additional port may extend through the filtration vessel 210 and may be designed to receive plumbing, conduits, pipes, fittings, fluid lines, and/or other similar components.

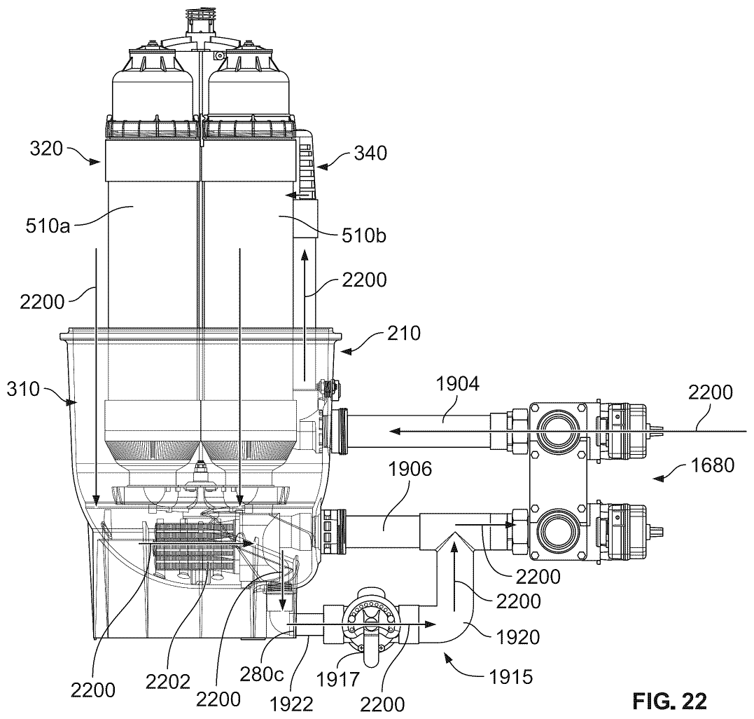

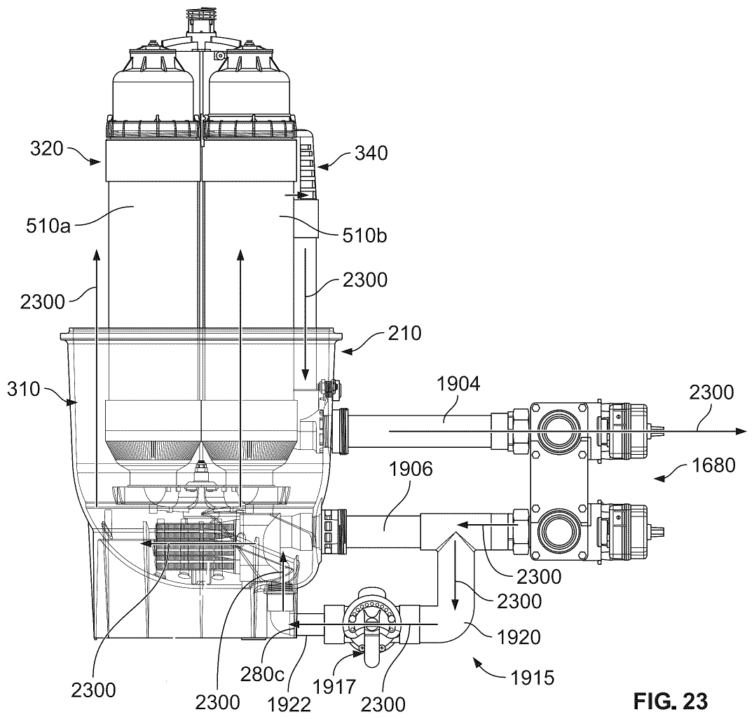

When the bypass valve 1917 is in the open position, the first and second bypass conduits 1920, 1922 may provide an alternative fluid flow path for water flowing through the hybrid filter assembly 200. Particularly, as will be described in more detail with reference to FIGS. 22 and 23, the bypass valve 1917 may be actuated such that the water is provided to the first filtration stage 310 while bypassing the second filtration stage 320.

In addition, when the bypass valve 1917 is in an open configuration, the drain port 280c and/or the additional port may provide an outlet for the fluid flowing through the first filtration stage 310. More particularly, the drain port 280c and/or the additional port may allow for the fluid provided to the first filtration stage 310 to flow out of the filtration vessel 210 without passing through the second filtration stage 320. When the bypass valve 1917 is opened, the drain port 280c and/or the additional port may minimize the headloss associated with the fluid flowing through the filtration vessel 210 by providing a flow path with less resistance than the flow path through the second filtration stage 320. Thus, fluid flow through the second filtration stage 320 may be partially, substantially, or completely reduced when the bypass valve 1917 is in an open position or open configuration.

Referring again to FIGS. 19 and 20, in some instances, the bypass assembly 1915 may be in fluid communication with a waste system. In such instances, the bypass valve 1917 may be provided as a three-way valve and in fluid communication with a waste conduit (not shown). Thus, in certain implementations, the bypass assembly 1915 may be designed to provide a fluid (e.g., a backwashing fluid) to the waste system. For example, if a backwashing fluid is provided to either of the first and second bypass conduits 1920, 1922 after the backwashing fluid has cleaned the first filtration stage 310 and/or the second filtration stage 320, the backwashing fluid may flow to the bypass valve 1917, through the waste conduit, and to the waste system. In addition, providing the bypass valve 1917 in the form of a three-way valve may allow for water and other contaminants to be disposed of via the drain port 280c even if the bypass assembly 1915 is coupled to the drain port 280c. In each case, the central controller 150 may direct actuation of the bypass valve 1917 such that the bypass valve 1917 is arranged or configured to provide fluid to the waste system.

In certain instances, the bypass valve 1917 may be positioned elsewhere in the hybrid filter assembly 200. For example, the bypass valve 1917 may be positioned at a T-junction 1930 coupling the first bypass conduit 1920 to the outlet conduit 1906. If the bypass valve 1917 is provided at the T-junction 1930, the bypass valve 1917 may be provided in the form of a three-way valve designed to control fluid flow through the bypass assembly 1915 and the outlet conduit 1906. In such instances, the central controller 150 may actuate the bypass valve 1917 to substantially or completely prevent fluid flow through the first and second bypass conduits 1920, 1922 and/or the outlet port 280b of the filtration vessel 210. In some instances, when the hybrid filter assembly 200 operates in the filtration mode, the central controller 150 may actuate the bypass valve 1917 and prevent fluid flow through the first and second bypass conduits 1920, 1922. In certain cases, when the hybrid filter assembly 200 is in the bypass mode, the central controller 150 may actuate the bypass valve such that fluid is allowed to flow out of the filtration vessel 210 and through the first and second bypass conduits 1920, 1922 while fluid flow is prevented through the outlet port 280b.

In certain instances, it may be advantageous to position the bypass valve 1917 outside of or external to the filtration vessel 210. By positioning the bypass valve 1917 outside of the filtration vessel, electrical components of the bypass valve 1917 may be protected from the high-pressure fluid flowing through the filtration vessel 210. Further, moving parts of the bypass valve 1917 (e.g., an actuator) may be protected from wear or damage associated with being in prolonged contact with the filtration media of the first filtration stage 310. However, it may also be advantageous to position the bypass valve 1917 inside the filtration vessel 210 to impart the hybrid filter assembly 200 with a smaller footprint. Thus, in some instances, the bypass valve 1917 may be positioned within the filtration vessel 210 of the hybrid filter assembly 200. For example, the bypass valve 1917 may be positioned below the membrane filtration modules of the second filtration stage 320 (e.g., below the first and second filtration modules 510a, 510b shown in FIG. 20). As an additional example, the bypass valve 1917 may be otherwise positioned in the bottom portion 1924 of the filtration vessel 210. In such instances, the bypass valve 1917 may be provided as a submersible three-way solenoid valve, although the bypass valve 1917 may also be provided in other forms. Furthermore, additional conduits or plumbing may be installed in the bottom portion 1924 of the filtration vessel 210 to place the bypass valve 1917 in fluid communication with the first filtration stage 310 and the outlet conduit 1906. When provided within the filtration vessel 210, the bypass valve 1917 may be designed to selectively allow fluid to flow through the outlet port 280b (and thus through the outlet conduit 1906) and/or the drain port 280c (and thus through the first and second bypass conduits 1920, 1922).

Turning to FIG. 21, the backwash valve assembly 1680 is further illustrated. In some instances, the backwash valve assembly 1680 may be coupled to a vessel (e.g., the filtration vessel 210 of the hybrid filter assembly 200) and may be in fluid communication with a pump (e.g., the pump 1630 of FIGS. 16 and 17). As best shown in FIG. 21, the backwash valve assembly 1680 may be provided in the form of a body 2108 including a feed line connection 2110, a filter inlet connection 2120, a filter outlet connection 2130, a pool return line connection 2140, and a waste line connection 2150, one or more ball valves, and one or more actuators. The feed line connection 2110 may be in fluid communication with the pump 1630 that is fluidly coupled to the inlet conduit 130 of FIG. 1. The filter inlet connection 2120 may be in fluid communication with the inlet port 280a of the filtration vessel 210. The filter outlet connection 2130 may be in fluid communication with the outlet port 280b of the filtration vessel 210. The pool return line connection 2140 may be in fluid communication with one or more of the discharge conduits 140a-140c of FIG. 1. The waste line connection 2150 may be in fluid communication with a waste system and/or may drain to the environment. In certain instances, the backwash valve assembly 1680 may include additional fluid line connections or be provided with fewer fluid line connections than described herein.

A first three-way ball valve 2160 may be designed to control the flow of fluid into and/or out of the feed line connection 2110, the filter inlet connection 2120, and/or the waste line connection 2150. A second three-way ball valve 2165 may be designed to control the flow into and/or out of the feed line connection 2110, the filter outlet connection 2130, and/or the pool return line connection 2140. Each of the first three-way ball valve 2160 and the second three-way ball valve 2170 may be controlled by a first actuator 2170a and a second actuator 2170b, respectively. Each of the first actuator 2170a and the second actuator 2170b may be provided in the form of a pneumatic actuator, such as the Pentair ProValve (manufactured by Pentair, Inc. of Golden Valley, Minnesota), a linear actuator, or a rotational actuator. Each of the first and second actuators 2170a, 2170b may be in electrical communication with the central controller 150 and may be directed or actuated by the central controller 150. In some instances, the first and second three-way ball valves 2160, 2165 and the first and second actuators 2170a, 2170b may control the flow of fluid through the various connection lines of the backwash valve assembly 1680 in other manners than those described herein.

FIG. 22 illustrates an example fluid flow path 2200 through the first filtration stage 310, the backwash valve assembly 1680, and the bypass assembly 1915 of the hybrid filter assembly 200. Fluid may follow the fluid flow path 2200 when the hybrid filter assembly 200 utilizes the bypass mode as a subroutine of the filtration mode. As such, fluid from the aquatic application 100 of FIG. 1 is still processed by the first filtration stage 310 while substantially all or all of the fluid bypasses the second filtration stage 320. To effectuate the bypass mode, the central controller 150 may actuate the bypass valve 1917 such that fluid is provided to the first filtration stage 310 while the one or more membrane filtration modules (e.g., the membrane filtration modules 510a-510d) of the second filtration stage 320 are bypassed. For example, the bypass valve 1917 may be actuated to an open configuration such that fluid is allowed to flow through the first and second bypass conduits 1920, 1922.

Referring again to FIG. 22, fluid from the swimming pool 110 may be provided to the hybrid filter assembly 200 via the inlet conduit 1904 when the hybrid filter assembly 200 operates in the filtration mode in conjunction with the bypass mode. More particularly, when the bypass mode is initiated by the central controller 150, fluid from the swimming pool 110 may follow the fluid flow path 2200. In such instances, the fluid may enter the hybrid filter assembly 200 via the inlet port 280a and flow through the diffuser 340, be filtered by the granular media 315 (see, e.g., FIG. 8), and flow through a sieve 2202. The sieve 2202 may be designed to help prevent the granular media 315 from exiting the filtration vessel 210. After flowing through the sieve 2202, the fluid may flow to the drain port 280c, through the first and second bypass conduits 1920, 1922 and the bypass valve 1917, and be provided back to the swimming pool 110 via the outlet conduit 1906. The first backwash valve 1902a may then direct the fluid filtered by the first filtration stage 310 to be provided to the swimming pool 110. In certain instances, the fluid flow path 2200 may be utilized when the second filtration stage 320 undergoes a chemical soaking and/or chemical cleaning.

In various instances, some, substantially all, or all of the fluid provided to the filtration vessel 210 may exit the filtration vessel 210 via the drain port 280c when the bypass valve 1917 is in the open configuration. For example, due to the high pressure within the filtration vessel 210, some fluid may still enter the second filtration stage 320 when the bypass valve 1917 is in the open configuration, particularly when the diameter of the drain port 280c is smaller than the diameter of the inlet port 280a and/or the outlet port 280b.

It is to be understood that the fluid flow path 2200 of FIG. 22 is an example fluid flow path, and the fluid from the swimming pool 110 may travel through the hybrid filter assembly 200 in other manners consistent with the teachings herein.

FIG. 23 illustrates an example fluid flow path 2300 through the hybrid filter assembly 200 when the hybrid filter assembly 200 utilizes the bypass mode as a subroutine of the backwash mode. Compared to the fluid flow path 2200, the direction of fluid flow in the fluid flow path 2300 is substantially reversed such that backwashing of the hybrid filter assembly 200 can be carried out. In addition, since the bypass mode is activated (and the bypass valve 1917 is in the open configuration) some, substantially all, or all of the backwashing fluid may be prevented from entering the second filtration stage 320.

The central controller 150 may initiate the backwash mode by actuating the first backwash valve 1902a of the backwash valve assembly 1680 and the bypass valve 1917 such that a backwashing fluid is provided to the drain port 280c of the filtration vessel 210. The backwashing fluid may flow to the drain port 280c via the first and second bypass conduits 1920, 1922, respectively. After the backwashing fluid is provided to the drain port 280c of the filtration vessel 210, the fluid may flow upwardly and through the granular media 315 (see, e.g., FIG. 11) and toward the diffuser 340. In some instances, the backwashing fluid may flow through the first filtration stage 310 in a manner substantially similar to the flow path for the backwashing fluid described with reference to FIG. 11. The fluid may then flow into the diffuser 340, exit the filtration vessel 210 via the inlet port 280a, and flow towards the second backwash valve 1902b of the backwash valve assembly 1680. The second backwash valve 1902b may then provide the backwashing fluid to a waste system or to a drain.

It is to be understood that, due to the pressure within the filtration vessel 210, some backwashing fluid may still enter the second filtration stage 320 when the bypass valve 1917 is in the open configuration. It is to be further understood that the fluid flow path 2300 of FIG. 23 is an example fluid flow path, and the backwashing fluid may travel through the hybrid filter assembly 200 in other manners consistent with the teachings herein.

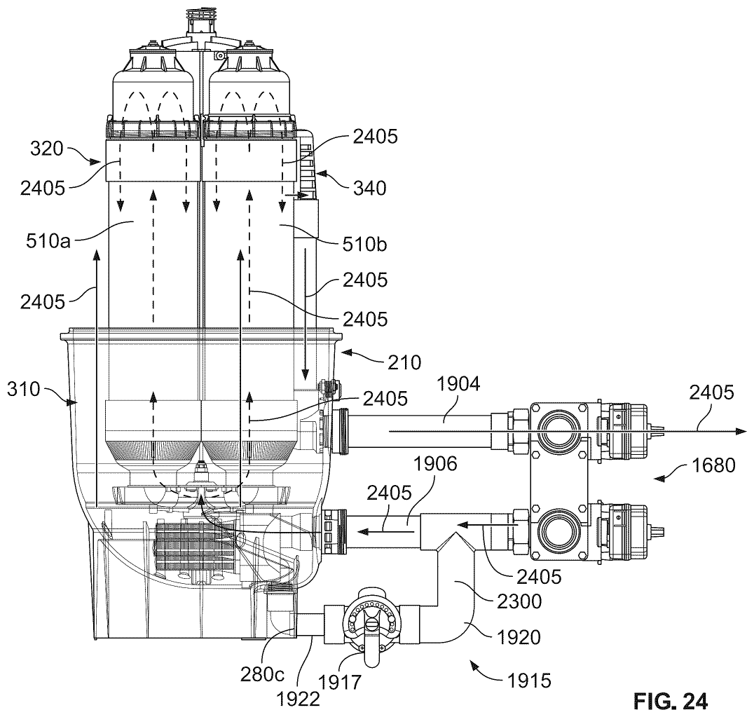

FIG. 24 illustrates an example fluid flow path 2400 through the hybrid filter assembly 200 when the hybrid filter assembly 200 operates in the backwash mode. Unlike the fluid flow path 2300, the fluid flow path 2400 may allow at least a portion of the backwashing fluid to enter the second filtration stage 320 via the fluid flow path 2405, since the bypass mode is not being utilized as a subroutine of the backwash mode. Since the bypass mode is not being utilized, the bypass valve 1917 may be arranged in the closed configuration, thereby preventing substantially all or all of the backwashing fluid from flowing into the filtration vessel 210 via the drain port 280c.

To initiate the backwash mode, the central controller 150 may actuate the first backwash valve 1902a of the backwash valve assembly 1680 to provide the backwashing fluid to the outlet conduit 1906. Then, as the backwashing fluid travels along the fluid flow path 2400, the backwashing fluid may enter the filtration vessel 210 via the outlet port 280b. After being provided to the outlet port 280b, the backwashing fluid may be provided to the first filtration stage 310 and the second filtration stage 320. In some instances, the backwashing fluid is provided to the second filtration stage 320 before being provided to the first filtration stage 310. In other instances, the backwashing fluid is provided substantially simultaneously to the first filtration stage 310 and the second filtration stage 320. When provided to the second filtration stage 320, the backwashing fluid may flow through the filtration modules of the second filtration stage 320 along the fluid flow path 2405 and in substantially the same manner as described with reference to FIG. 10. When provided to the first filtration stage 310, the backwashing fluid may flow through the first filtration stage 310 (and thus the granular media 315) in substantially the same manner as described with reference to FIG. 11.

After the first and second filtration stages 310, 320 have been backwashed, the backwashing fluid may flow through the diffuser 340 and exit the filtration vessel 210 via the inlet port 280a. The backwashing fluid may then flow through the inlet conduit 1904 and to the second backwash valve 1902b before being provided by the second backwash valve 1902b to a waste system or a drain.

It is to be understood that the fluid flow paths 2400, 2405 of FIG. 24 are example fluid flow paths, and the backwashing fluid may travel through the hybrid filter assembly 200 in other ways consistent with the teachings herein.

The backwash valve assembly 1680 and the bypass assembly 1915 can be automated. For instance, one or more of the above valves or components of the above-described systems can be communicatively coupled to the central controller 150 of FIG. 1. The central controller 150 is designed to control the function and operation of the hybrid filter assemblies disclosed herein. The central controller 150 may work in conjunction with, or independent from, one or more local controllers associated with the swimming pool components 102 disclosed herein. Automating the backwash valve assembly 1680 and the bypass assembly 1915 allows users to more easily switch between the filtration and cleaning modes of the hybrid filter assembly 200.

It is to be understood that the filtration mode, the chemical cleaning mode, the backwash mode, the bypass mode, and the variations of the foregoing discussed herein may be effectuated by the backwash valve assembly 1680 and the bypass assembly 1915 acting independently of and/or in concert with each other. For example, in certain cases, the central controller 150 can direct actuation of the bypass valve 1917 and the first and second backwash valves 1902a, 1902b to place the hybrid filter assembly 200 in the backwash mode. As an additional example, the central controller 150 can direct actuation of the bypass valve 1917 and the first and second backwash valves 1902a, 1902b such that the first filtration stage 310 filters fluid from the aquatic application 100 of FIG. 1 when the second filtration stage 320 is offline (e.g., for a chemical soaking or cleaning process).

It is also to be understood that the backwash valve assembly 1680 and the bypass assembly 1915 may be actuated multiple times by the central controller 150. For example, the central controller 150 may actuate each of the backwash valve assembly 1680 and the bypass assembly 1915 into a first configuration at a first time period to place the hybrid filter assembly 200 into a first operational mode (e.g., the filtration mode). The central controller 150 may also actuate each of the backwash valve assembly 1680 and the bypass assembly 1915 into a second configuration at a second time period to place the hybrid filter assembly 200 into a second operational mode (e.g., a chemical cleaning mode in which the bypass mode is utilized as a subroutine of the chemical cleaning mode). In the spirit of the disclosure of FIGS. 19-24, other variations of initiating the operational modes of the hybrid filter assembly 200 may be implemented than those described herein.

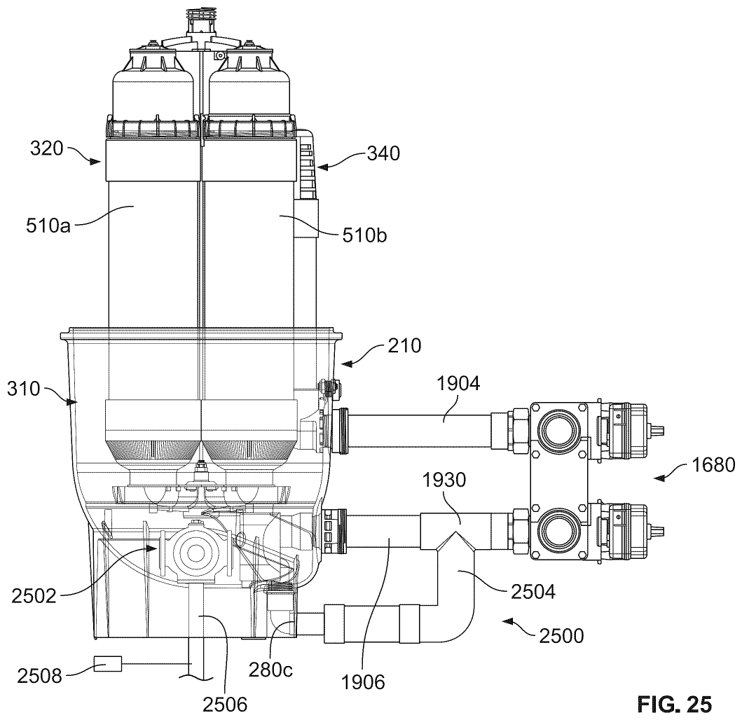

FIG. 25 illustrates an alternative implementation of a bypass assembly (i.e., a bypass assembly 2500) in the hybrid filter assembly 200. Components of the bypass assembly 2500 with similar names to those of the bypass assembly 1915 may have substantially similar structure and/or function as the components of the bypass assembly 1915. For example, like the bypass assembly 1915, the bypass assembly 2500 may include a bypass valve 2502 in fluid communication with the drain port 280c and a bypass conduit 2504. However, unlike the bypass assembly 1915, the bypass assembly 2500 may further include a rotatable shaft 2506 coupled to the bypass valve 2502 and an actuator 2508. Together, the rotatable shaft 2506 and the actuator 2508 may be designed to alter the configuration of the bypass valve 2502 (e.g., by placing the bypass valve 2502 in an open configuration, a closed configuration, and/or a filtration configuration).

In the instance provided in FIG. 25, the bypass valve 2902 is provided in the form of a three-way valve, although the bypass valve may also be provided in other forms (e.g., a two-way valve, a six-way valve, etc.). In certain instances, the bypass valve 2902 may be provided as a mechanically actuatable valve that may be actuated into various configurations. For example, the bypass valve 2902 may be provided in the form of a rotary valve, a ball valve, a gate valve, a directional control valve, and other similar valves designed to control fluid flow through conduits. In certain cases, the bypass valve 2902 may be in fluid communication with one or more of the inlet port 280a, the outlet port 280b, the drain port 280c, and any additional ports provided in the filtration vessel 210. When the bypass valve 2902 is in the open configuration, the hybrid filter assembly 200 may operate in the bypass mode. Thus, fluid may be provided to the bypass conduit 2504, thereby fluidly isolating the second filtration stage 320. When the bypass valve 2902 is in the closed configuration, the hybrid filter assembly 200 may be operating in the filtration mode or the backwash mode. In such instances, fluid may be allowed to flow through both the first filtration stage 310 and the second filtration stage 320. In some instances, the bypass valve 2902 may also be placed in a filtration configuration such that fluid may flow from the inlet port 280a, to the first and second filtration stages 310, 320, and exit the hybrid filter assembly 200 via the outlet port 280b.

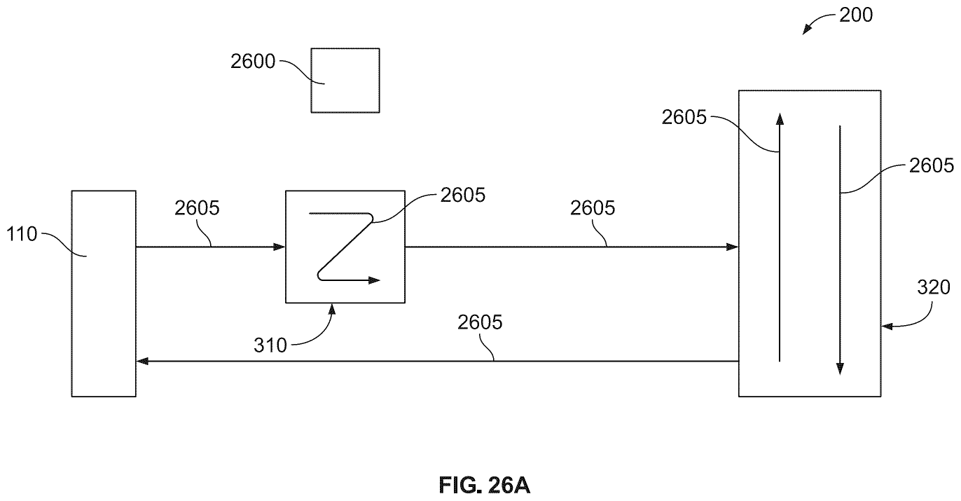

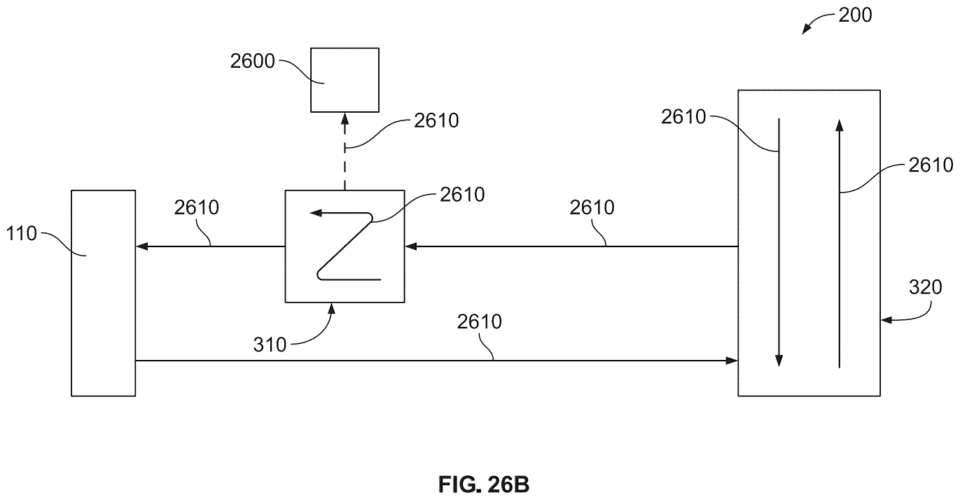

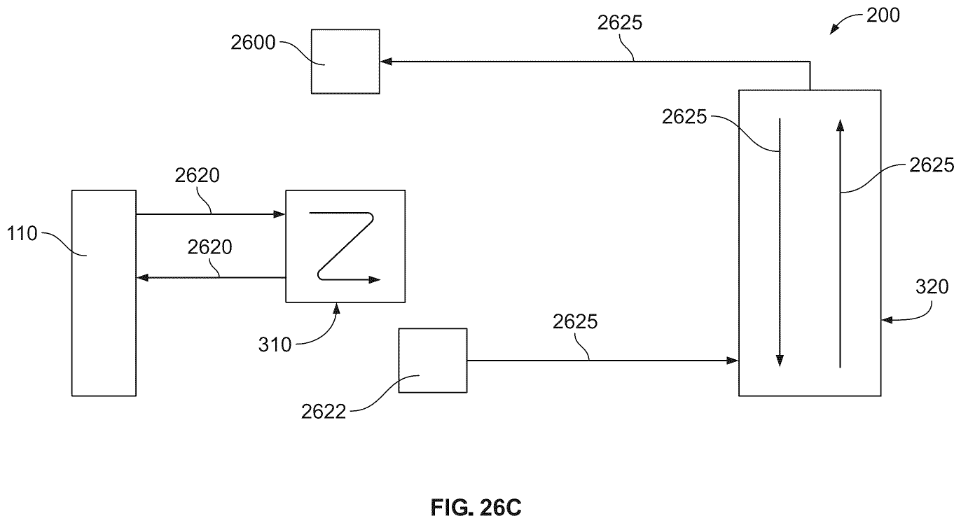

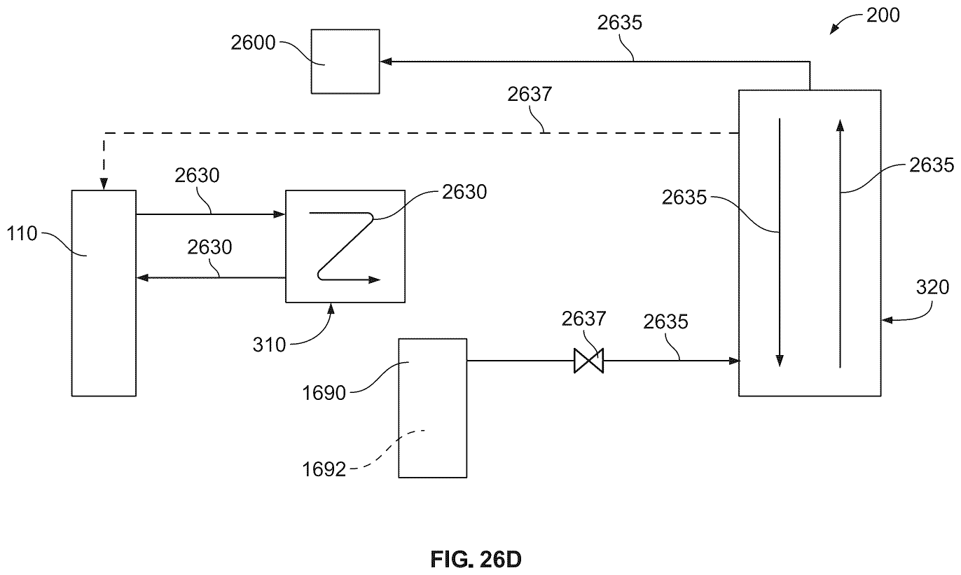

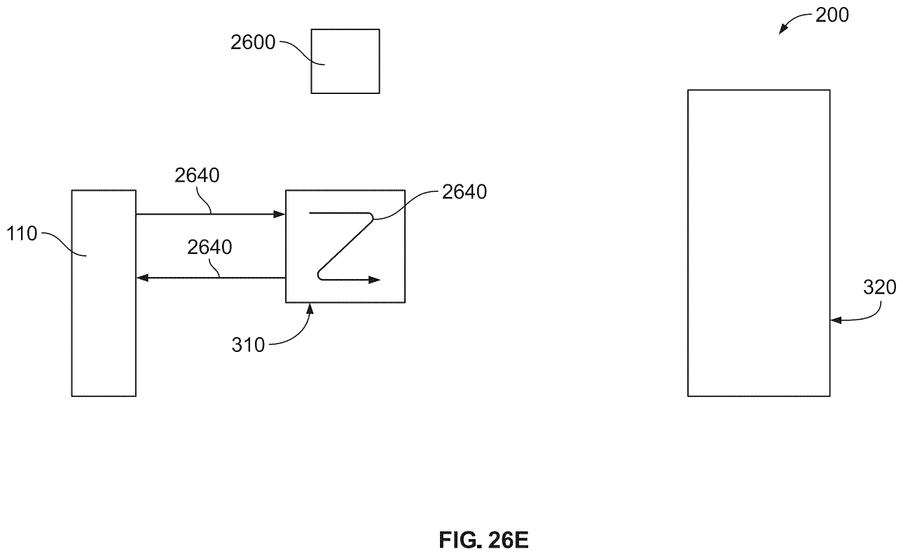

Together, FIGS. 26A-26E illustrate non-limiting examples of fluid flow paths through the hybrid filter assembly 200 when the hybrid filter assembly 200 operates in various modes (e.g., a filtration mode, a backwash mode, a chemical cleaning mode, and/or a bypass mode). In particular, FIGS. 26A-26E illustrate simplified fluid flow paths associated with the swimming pool 110 of FIG. 1, the first filtration stage 310, the second filtration stage 320, a waste system 2600, and, in some instances, the chemical feed tank 1690. In certain instances, the waste system 2600 may be provided as a drain, a container, a sewer system, and/or other similar systems capable of receiving a backwashing fluid and/or a flushing fluid. Other fluid flow paths besides those illustrated in FIGS. 26A-26E may be utilized in accordance with the teachings provided herein. In addition, the fluid flow paths described in FIGS. 26A-26E may also be utilized in any of the hybrid filter assemblies, and variations thereof, described herein.

FIG. 26A illustrates an example fluid flow path associated with the swimming pool 110, the first filtration stage 310, and the second filtration stage 320 when the hybrid filter assembly 200 operates in a filtration mode. The central controller 150 may be designed to initiate the filtration mode. For example, the central controller 150 may direct actuation of one or more components of the hybrid filter assembly 200 (e.g., backwash valve assembly 1680 and/or the bypass assembly 1915 of FIGS. 19-25) to place the hybrid filter assembly 200 into the filtration mode. In the filtration mode, fluid may flow along fluid flow path 2605. For example, water may be provided from the swimming pool 110 and to the first filtration stage 310, which in turn filters the water from the swimming pool 110, creating a prefiltered water. The prefiltered water from the first filtration stage 310 may then be provided to the second filtration stage 320. As the prefiltered water flows through the second filtration stage 320, the prefiltered water undergoes further filtration within the membrane filtration modules (e.g., the membrane filtration modules 510 of FIG. 5A) provided in the second filtration stage 320. After the prefiltered water is processed by the second filtration stage, a filtered water is generated. In the illustrated instance of FIG. 26A, the filtered water is provided back to the swimming pool 110.

FIG. 26B illustrates an example fluid flow path associated with the swimming pool 110, the first filtration stage 310, the second filtration stage 320, and the waste system 2600 when the hybrid filter assembly 200 operates in an instance of the backwash mode. The central controller 150 may be designed to initiate the backwash mode. For example, the central controller 150 may direct actuation of one or more components of the hybrid filter assembly 200 (e.g., backwash valve assembly 1680 and/or the bypass assembly 1915 of FIGS. 19-25) to place the hybrid filter assembly 200 into the backwash mode. In certain instances, when the hybrid filter assembly 200 operates in a backwash mode, fluid may flow along a fluid flow path 2610 that is substantially opposite of the fluid flow path 2605. In some such instances, water may first flow from the swimming pool 110 and to the second filtration stage 320. Once provided to the second filtration stage 320, the water may be utilized to backwash the membrane filtration modules (e.g., the membrane filtration modules 510 of FIG. 5A) provided in the second filtration stage 320. Then, the water (and, optionally, contaminants) may exit the second filtration stage 320 and flow to the first filtration stage 310. Once provided to the first filtration stage 310, the water may backwash the first filtration stage 310. After the water exits the first filtration stage 310, the water (and optionally contaminants) may then be provided to the waste system 2600 via a waste conduit in fluid communication with the first filtration stage 310 and the waste system 2600.

In some cases, only one of the first filtration stage 310 or the second filtration stage 320 may be provided with a backwashing fluid. For example, the backwashing fluid may be provided from the second filtration stage 320 and to the waste system 2600 without being provided to the first filtration stage 310. As an additional example, the backwashing fluid may be provided to the first filtration stage 310 without first flowing through the second filtration stage 320.

In some cases, the swimming pool 110 may not be used as the source of the backwashing fluid. In such cases, a source of prefiltered water or filtered water may be used to backwash the first filtration stage 310 and the second filtration stage 320. For example, the first filtration stage 310 may provide a prefiltered fluid that may be utilized as a backwashing fluid when the second filtration stage 320 is backwashed.

FIG. 26C illustrates an example fluid flow path associated with the swimming pool 110, the first filtration stage 310, the second filtration stage 320, and the waste system 2600 when the hybrid filter assembly 200 operates in another (e.g., a second) instance of the backwash mode. The central controller 150 may be designed to initiate the backwash mode. For example, the central controller 150 may direct actuation of one or more components of the hybrid filter assembly 200 (e.g., backwash valve assembly 1680 and/or the bypass assembly 1915 of FIGS. 19-25) to place the hybrid filter assembly 200 into the backwash mode. In this instance of the backwash mode, the bypass mode described with reference to FIG. 26E is utilized as a subroutine of the backwash mode such that some of the filtration capabilities of the hybrid filter assembly 200 remain online while a backwash is being carried out. As provided in FIG. 26C, a fluid flow path 2620 may allow for water from the swimming pool 110 to be processed by the first filtration stage 310. In turn, the first filtration stage 310 may generate a prefiltered fluid which is provided back to the swimming pool 110. In addition, a source 2622 of a backwashing fluid is provided to the second filtration stage 320 via a fluid flow path 2625. Once the backwashing fluid is provided to the second filtration stage 320, the backwashing fluid may be utilized to backwash the membrane filtration modules (e.g., the membrane filtration modules 510 of FIG. 5A) provided in the second filtration stage 320. After the backwashing of the second filtration stage 320 is complete, the backwashing fluid may then be provided to the waste system 2600.

In some instances, the source 2622 of the backwashing fluid may be the swimming pool 110. In other instances, the source 2622 of the backwashing fluid may be another portion of the plumbing associated with the aquatic application 100 of FIG. 1. In yet other instances, the source 2622 of the backwashing fluid may be fluid that has been filtered by the first filtration stage 310 and/or the second filtration stage 320. In certain cases, the backwashing fluid provided from the source 2622 may also include or be dosed with a cleaning agent (e.g., the chemical cleaning agent 1692 described with reference to FIG. 16).

FIG. 26D illustrates an example fluid flow path associated with the swimming pool 110, the chemical feed tank 1690, the first filtration stage 310, the second filtration stage 320, and the waste system 2600 when the hybrid filter assembly 200 operates in a chemical cleaning mode that utilizes the bypass mode of FIG. 26E as a subroutine of the chemical cleaning mode. The central controller 150 may be designed to initiate the chemical cleaning mode and the associated bypass mode subroutine. For example, the central controller 150 may direct actuation of one or more components of the hybrid filter assembly 200 (e.g., backwash valve assembly 1680 and/or the bypass assembly 1915 of FIGS. 19-25) to place the hybrid filter assembly 200 into the chemical cleaning mode and to fluidly isolate the second filtration stage 320 from the first filtration stage 310. As provided in FIG. 26D, a fluid flow path 2630 may allow for water from the swimming pool 110 to be processed by the first filtration stage 310. In turn, the first filtration stage 310 may generate a prefiltered fluid that is provided back to the swimming pool 110. In addition, the chemical feed tank 1690 may be in fluid communication with the second filtration stage 320. When the central controller 150 of FIG. 1 initiates the chemical cleaning mode, the valve 2636 may provide the chemical cleaning agent 1692 to the second filtration stage 320 via a fluid flow path 2635. As shown, the fluid flow path 2635 may allow for fluid to flow through the second filtration stage 320 in the same direction as the fluid flow path 2625 described with reference to FIG. 26C. In other instances, the fluid flow path 2635 may allow for fluid to flow through the second filtration stage 320 in the same direction as the fluid flow path 2605 described with reference to FIG. 26A. After the chemical agent 1692 is provided to the membrane filtration modules (e.g., the membrane filtration modules 510 of FIG. 5A) provided in the second filtration stage 320, the chemical cleaning agent 1692 may be flushed from the second filtration stage 320 and provided to the waste system 2600 via the fluid flow path 2635. Optionally, some, substantially all, or all of the flushing fluid containing the chemical agent may be directed to the swimming pool 110 via a fluid flow path 2637.

In some instances of the chemical cleaning mode described with reference to FIG. 26D, the flushing fluid may be a backwashing fluid provided to the second filtration stage 320, as described with reference to FIG. 26C. In yet other instances of the chemical cleaning mode described with reference to FIG. 26D, the flushing fluid may be a backwashing fluid provided to the second filtration stage 320, as described with reference to FIG. 26B. In such instances, the flushing fluid, and thus the chemical cleaning agent 1692, may be provided to the first filtration stage 310 before being provided to the waste system 2600 and/or the swimming pool 110. In yet other instances, the flushing fluid may be provided from the swimming pool 110, the first filtration stage 310, and/or other plumbing provided with the aquatic application 100 of FIG. 1.

In certain instances of the chemical cleaning mode described with reference to FIG. 26D, the valve 2636 is omitted. In some instances of the chemical cleaning mode described with reference to FIG. 26D, a dosing mechanism or pump is provided in the fluid flow path 2635 such that the chemical cleaning agent 1692 may be metered and/or delivered to the second filtration stage 320.

FIG. 26E illustrates an example fluid flow path associated with the swimming pool 110 and the first filtration stage 310 when the hybrid filter assembly 200 operates in a bypass mode. The central controller 150 may be designed to initiate the bypass mode. For example, the central controller 150 may direct actuation of one or more components of the hybrid filter assembly 200 (e.g., backwash valve assembly 1680 and/or the bypass assembly 1915 of FIGS. 19-25) to place the hybrid filter assembly 200 into the bypass mode. When the hybrid filter assembly 200 operates in a bypass mode, water from the swimming pool 110 may be provided only to the first filtration stage 310. For example, water from the swimming pool 110 may flow along a fluid flow path 2640 to the first filtration stage 310. Once the water from the swimming pool 110 is provided to the first filtration stage 310, the water may be processed and a prefiltered water may be generated. The prefiltered water generated by the first filtration stage 310 may then be provided to the swimming pool 110 without being provided to the second filtration stage 320.

In other instances of the bypass mode, fluid from the swimming pool 110 may not be provided to either the first filtration stage 310 or the second filtration stage 320. In such instances, the water from the swimming pool 110 may instead be routed to other components of the aquatic application 100 described with reference to FIG. 1.

While the example fluid flow paths of FIGS. 26A-26E are described with reference to the hybrid filter assembly 200, the fluid flow paths may be associated with any of the hybrid filter assemblies (and any variations thereof) described herein. It is also to be understood that structural components of the hybrid filter assembly 200 (e.g., the filtration vessel 210 which houses the first and second filtration stages 310, 320) were omitted from FIGS. 26A-26E for clarity. Further, the central controller 150 may work in conjunction with, or independent from, one or more local controllers associated with the pool components 102 of FIG. 1 to effectuate the operational modes described with reference to FIGS. 26A-26E. Alternatively, one or more local controllers associated with the pool components 102 may work in conjunction with, or independent from, the central controller 150 to effectuate the operational modes described with reference to FIGS. 26A-26E.

As discussed above, the central controller 150 and/or one or more local controllers may be designed to perform the above methods or to place the hybrid filter assembly 200 in various operational modes (e.g., the filtration mode, the cleaning mode, the bypass mode, and combinations and variations thereof). Referring back to FIG. 1, the central controller 150 can receive data from one or more of the components of the aquatic application 100, analyze the data as discussed herein, and execute one or more of the methods or processes described herein. Thus, the central controller 150 can create a communication link that operatively connects the plurality of system components. Accordingly, the central controller 150 may include one or more of a receiver, a memory, a processor, and a transmitter.

The receiver can be designed to receive transmitted data from the aquatic application 100. For example, as discussed above, the aquatic application 100 may include one or more of a flow meter, a pressure transducer, a temperature sensor, and the like to monitor various system operational parameters. Thus, the receiver can receive the transmitted data from the one or more sensors. In some instances, the receiver can receive data inputs from a user. For example, a user can input a preferred schedule for a backwash operation.

The memory can be designed to store system information received from the one or more system components and/or user inputs. In some instances, the memory can be integrated with one or more of the system components discussed herein. In other instances, the memory can be implemented as a stand-alone memory unit.

The processor can be a programmable processor communicatively coupled to the memory. In some embodiments, the programmable processor may include program instructions that are stored on a cloud server non-transitory computer-readable medium and that are executable by the programmable processor to perform one or more of the methods described herein.

The transmitter can be designed to send the instructions from the processor to the one or more system components. Thus, the above methods can be automated. For example, the central controller 150 can be designed to control the backwash valve assembly 1680 during the filtration mode and/or the backwash mode. As an additional example, the central controller 150 can be designed to control the bypass assembly 1915 during the bypass mode. As another example, the central controller 150 may control the backwash valve assembly 1680 and the bypass assembly 1915 simultaneously, substantially simultaneously, sequentially, or in other manners to carry out any of the operational modes described herein.

Further, in some instances, one or more of the above methods can use machine learning (ML), artificial intelligence (AI), or similar technologies, to iteratively train the central controller and improve the performance of the system based on one or more feedback parameters, characteristics, or similar. For example, in some instances, ML/AI can be used to predict an optimal cleaning schedule based on system data such as filter loading data, bather load data, geographic location of the system, weather data, user preferences, and the like. In some instances, ML/AI can be used to provide accurate chemical dosing and/or predict chemical usage trends. Thus, the system can be optimized to reduce fluctuations in the chemical dosage. This can be beneficial because it can reduce the likelihood of high chemical concentrations in the pool water, which can irritate bathers. Additionally, it can help a user determine an amount of chemicals that are needed for the system and/or when to reorder chemicals.

In some instances, a lookup table of predetermined values, thresholds, ranges, and other information may be stored by a controller (e.g., the central controller 150 and/or the local controllers of the pool components 102), and the controller may determine an appropriate action based on one or more of the variables discussed herein. In addition, the controller may include pre-stored lookup tables. Furthermore, the controller may be in communication with a network (e.g., the cloud network 170 of FIG. 1) and may be capable of downloading lookup tables. The controller may select threshold values (e.g., a threshold permeability value, a threshold temperature value) from the lookup tables based on a number of factors including a determined pressure, flow rate, temperature, pH, turbidity, free chlorine content, ORP value, and/or other parameters. A detailed discussion of the various predetermined values, thresholds, ranges, and other information that may be utilized by the controller to determine an appropriate action can be found in U.S. patent application Ser. Nos. 18/936,550 and 18/936,822, each entitled “Hybrid Filter and Chemical Cleaning Assembly and Method” and filed on Nov. 4, 2024, the contents of which are incorporated herein by reference in their entirety.

It is to be understood that descriptions of the central controller 150, and the functionality of the central controller 150, may also apply to one or more of the local controllers of the pool components 102.

While various methods of operating the hybrid filter assembly 200 (e.g., the various operational modes) are disclosed herein, detailed discussions of other methods of operating the hybrid filter assembly 200 can be found in U.S. patent application Ser. Nos. 18/936,550 and 18/936,822, each entitled “Hybrid Filter and Chemical Cleaning Assembly and Method” and filed on Nov. 4, 2024, the contents of which are incorporated herein by reference in their entirety.

It will be further appreciated by those skilled in the art that while the above disclosure has been described above in connection with particular embodiments and examples, the above disclosure is not necessarily so limited, and that numerous other embodiments, examples, uses, modifications, and departures from the embodiments, examples, and uses are intended to be encompassed by the claims attached hereto. The entire disclosure of each patent and publication cited herein is incorporated by reference, as if each such patent or publication were individually incorporated by reference herein. Various features and advantages of the above disclosure are set forth in the following claims.

We claim:

1. A hybrid filter assembly for an aquatic application, comprising:
a vessel including a first port and a second port, wherein the first port receives fluid from the aquatic application;
a first filtration stage and a second filtration stage retained within the vessel, wherein the first filtration stage is designed to filter particles imparted with a first size and the second filtration stage is designed to filter particles imparted with a second size;
a bypass assembly in fluid communication with the second port; and
a controller in communication with the bypass assembly, wherein the controller actuates the bypass assembly to alter an operational state of the hybrid filter assembly.

2. The hybrid filter assembly of claim 1, wherein the operational state of the hybrid filter assembly includes a filtration mode, a cleaning mode, and a bypass mode.

3. The hybrid filter assembly of claim 1, wherein the second port is provided in the form of a drain port which is in fluid communication with a waste system.

4. The hybrid filter assembly of claim 1, wherein substantially all the fluid from the aquatic application bypasses the second filtration stage when the operational state of the hybrid filter assembly is in a bypass mode.

5. The hybrid filter assembly of claim 1, wherein:
the vessel further includes a third port in fluid communication with an outlet conduit, the outlet conduit designed to provide filtered water from the hybrid filter assembly to the aquatic application, and
the bypass assembly further includes:
a bypass conduit in communication with the third port of the vessel; and
a bypass valve in fluid communication with the bypass conduit,
wherein a filtered fluid is provided to the bypass conduit when the bypass valve is in a first configuration.

6. The hybrid filter assembly of claim 5, wherein the bypass valve is retained within a bottom portion of the vessel and is positioned below the second filtration stage.

7. The hybrid filter assembly of claim 5, wherein the bypass valve is positioned outside of the vessel and the bypass valve is in fluid communication with the vessel via the second port.

8. The hybrid filter assembly of claim 1 further comprising:
a backwash assembly in fluid communication with the first port and a third port of the vessel, the backwash assembly provided in the form of:
a first backwash valve; and
a second backwash valve in fluid communication with the first backwash valve,
wherein the backwash assembly is designed to provide a fluid from the aquatic application to the vessel when the hybrid filter assembly operates in a filtration mode and is further designed to provide a backwash fluid to the vessel when the hybrid filter assembly operates in a cleaning mode.

9. The hybrid filter assembly of claim 1, wherein the controller can initiate a bypass mode to operate concurrently with a filtration mode and the second filtration stage is substantially fluidly isolated from the first filtration stage when the bypass mode is operational.

10. The hybrid filter assembly of claim 9, wherein the controller activates the bypass mode when the controller initiates a chemical cleaning of the second filtration stage.

11. A hybrid filter assembly for a pool or spa, comprising:
a first filtration stage and a second filtration stage each arranged within a filtration vessel, wherein the second filtration stage includes a plurality of filtration modules;
an inlet conduit and an outlet conduit each in fluid communication with the filtration vessel, wherein the inlet conduit is designed to provide a fluid from the pool or spa to the hybrid filter assembly and the outlet conduit is designed to provide a filtered fluid from the filtration vessel to the pool or spa;
a backwash valve assembly including a valve system designed to provide a backwashing fluid to the filtration vessel when the hybrid filter assembly operates in a backwash mode; and
a bypass assembly including a bypass valve in fluid communication with a drain port of the filtration vessel, the bypass assembly designed to selectively fluidly isolate the second filtration stage.

12. The hybrid filter assembly of claim 11 further including a controller in electronic communication with the backwash valve assembly and the bypass assembly.

13. The hybrid filter assembly of claim 12, wherein the controller actuates the valve system of the backwash valve assembly at a first time period to provide the backwashing fluid to the first filtration stage, and the controller actuates the bypass valve of the bypass assembly at a second time period to fluidly isolate the second filtration stage from the first filtration stage.

14. The hybrid filter assembly of claim 11 further including a bypass conduit designed to place the bypass valve into fluid communication with the drain port and the outlet conduit.

15. The hybrid filter assembly of claim 14, wherein fluid is provided from the first filtration stage to the bypass conduit and the outlet conduit when the bypass valve is in an open configuration.

16. A hybrid filter assembly for an aquatic application, comprising:
a filtration vessel including a first port, a second port, and a third port each including an aperture extending through a body of the filtration vessel;
a first conduit in fluid communication with the first port and a source of fluid from the aquatic application;
a second conduit in fluid communication with the second port and designed to provide an output of the filtration vessel to the aquatic application;
a backwash valve assembly provided in the form of a first valve, a second valve, and a valve conduit coupled to each of the first valve and the second valve; and
a bypass valve assembly designed to selectively allow fluid to exit the filtration vessel via the third port.

17. The hybrid filter assembly of claim 16, the bypass valve assembly further including:
a bypass valve positioned in an interior of the filtration vessel;
a rotatable shaft coupled to the bypass valve, the rotatable shaft extending from an interior of the filtration vessel and outwardly and away from the body of the filtration vessel; and
an actuator in communication with the rotatable shaft,
wherein the rotatable shaft is designed to actuate the bypass valve between an open configuration and a closed configuration.

18. The hybrid filter assembly of claim 16, wherein the filtration vessel includes a granular media arranged upstream of a filtration module, and the fluid from the aquatic application bypasses the filtration module when a bypass valve of the bypass valve assembly is in an open configuration.

19. The hybrid filter assembly of claim 18, wherein substantially all of the fluid provided from the aquatic application flows through the filtration module and exits the filtration vessel via the second conduit when the bypass valve is in a closed configuration.

20. The hybrid filter assembly of claim 16, wherein the first valve provides fluid to the second valve via the valve conduit when fluid from the aquatic application bypasses the filtration vessel.
